(19) United States
(12) Patent Application Publication
(10) Pub. No.: US 2016/0266695 A1
(43) Pub. Date: Sep. 15, 2016

(54) DISPLAY APPARATUS HAVING IMAGE SCANNING FUNCTION

(71) Applicant: CRUCIALTEC CO., LTD., Gyeonggi-do (KR)

(72) Inventors: Byung Seong Bae, Gyeonggi-do (KR); Jong Uk Kim, Gyeonggi-do (KR); Jae Heung Kim, Gyeonggi-do (KR); Chang Sup Shim, Gyeonggi-do (KR); Ga Won Choi, Gyeonggi-do (KR); Ho Sik Jeon, Chungcheongnam-do (KR); Woo Young Choi, Seoul (KR); Jun Suk Lee, Gyeonggi-do (KR); So Hyun Jeong, Chungcheongnam-do (KR); Ju An Yoon, Chungcheongnam-do (KR); Sang A Oh, Seoul (KR)

(21) Appl. No.: 15/066,668

(22) Filed: Mar. 10, 2016

Related U.S. Application Data
(60) Provisional application No. 62/130,857, filed on Mar. 10, 2015.

(51) Int. Cl. G06F 3/041; G06F 1/16; G09G 3/36; G06F 3/042; G06K 9/00

(52) U.S. Cl. CPC G06F 3/0412; G06F 3/0416; G06F 3/0421; G06K 9/0004; G06K 9/00053; G09G 3/3648; G06F 1/1696; G09G 2358/00

(57) ABSTRACT

Disclosed is a fingerprint-sensing display capable of sensing a fingerprint on a display screen. The display apparatus having an image scanning function includes an optical amplification cover, one side of which forms a display surface, including a transparent optical amplification layer configured to amplify an optical pattern generated by a fingerprint of a user in contact with the display surface and a cover window for reinforcement, a thin film transistor (TFT) array configured to drive a plurality of pixels forming an image, and an optical sensor array disposed between the optical amplification cover and the TFT array and configured to sense the optical pattern amplified by the optical amplification cover.

### CROSS-REFERENCE TO RELATED APPLICATION

This application claims priority to and the benefit of U.S. Provisional Application No. 62/130,857, filed on Mar. 10, 2015, the disclosure of which is incorporated herein by reference in its entirety.

### BACKGROUND

1. Field of the Invention

The present invention relates to a display apparatus capable of scanning a surface image of an object on a display surface, and more particularly, to a display apparatus not only having a display function but also including a sensor array detecting a fingerprint by receiving light reflected from a fingerprint pattern.

2. Discussion of Related Art

As security problems in information and communication have become an issue, security-related technology has become a topic in the field of personal mobile devices, such as smartphones or tablet PCs. In particular, as electronic commerce (e-commerce) through mobile devices of users increases, security for personal information is required. Accordingly, technology to identify and authenticate a person using biometric information, such as fingerprints, irises, faces, voices, or veins is being utilized. Among various technologies for biometric information authentication, the most commonly used is authentication technology using fingerprints. In recent years, products such as smartphones and tablet PCs have been released that incorporate fingerprint recognition and authentication technology. However, in order to combine a fingerprint sensor device with a mobile device, a display apparatus and a fingerprint sensor device need to be installed together in the mobile device. Accordingly, there is a problem in that the size and thickness of the mobile device increase.

Mobile devices including smartphones and tablet PCs are frequently exposed to the risk of shock, friction, and scratches. Accordingly, in order to protect touch interfaces and display apparatuses from such dangers, mobile devices generally have a tempered glass cover. The tempered glass cover is an important component, but may limit the sensitivity of the sensor for the purpose of fingerprint recognition. Accordingly, methods and devices are needed for overcoming this impediment.

### SUMMARY OF THE INVENTION

The present invention is directed to a display apparatus having an image scanning function. The display apparatus is formed to secure sufficient sensor sensitivity for fingerprint recognition with no degradation in display performance and have durability suitable for mobile devices user environments.

According to an aspect of the present invention, there is provided a display apparatus having an image scanning function including an optical amplification cover, one side of which forms a display surface, including a transparent optical amplification layer configured to amplify an optical pattern generated by a fingerprint of a user in contact with the display surface and a cover window for reinforcement, a thin film transistor (TFT) array configured to drive a plurality of pixels forming an image, and an optical sensor array disposed between the optical amplification cover and the TFT array and configured to sense the optical pattern amplified by the optical amplification cover.

The transparent optical amplification layer may include a plurality of quantum dots absorbing light of a first wavelength band and emitting light of a second wavelength band different from the first wavelength band. The first wavelength band may belong to a band of visible light and the second wavelength band may belong to a band of infrared light.

The transparent optical amplification layer may include a polarization-converting layer, and the polarization-converting layer may include a plurality of quantum dots absorbing first polarized light and emitting second polarized light with a polarization axis that is substantially perpendicular to that of the first polarized light.

The optical amplification cover may include a cover window, one side of which forms a display surface, and a transparent optical amplification layer formed on the other side of the display surface of the cover window.

The optical amplification cover may include a cover window, a transparent optical amplification layer formed on an upper surface of the cover window, and a protection layer formed on an upper surface of the transparent optical amplification layer and having a surface forming a display surface. The optical sensor array may be formed on a lower surface of the cover window.

The TFT array and the optical sensor array may two-dimensionally overlap to form a part of a sensor-integrated display panel.

The sensor-integrated display panel may be a liquid crystal display (LCD) panel and may include a lower substrate portion including a TFT array configured to drive the plurality of pixels on an inner side of a lower substrate, and an upper substrate portion including a black matrix formed to correspond to an opaque portion of the TFT array and shielding visible light and an optical sensor array disposed to overlap the black matrix on an inner side of an upper substrate.

In this case, the black matrix may be formed of an infrared filter resin shielding visible light and transmitting infrared light, and the optical sensor array may include a plurality of infrared sensors. The plurality of infrared sensors may be respectively arranged to two-dimensionally overlap TFTs configured to drive pixel electrodes in the TFT array.

In the sensor-integrated display panel, the optical sensor array may include a metal interconnection and an optical sensor disposed on an inner side of the black matrix. The upper substrate portion may further include an optical waveguide formed in a portion of the black matrix corresponding to the optical sensor, or at least one microlens formed in a portion corresponding to the optical sensor.

In the sensor-integrated display panel, the optical sensor array may include an interconnection and an optical sensor disposed between the upper substrate and the black matrix. The interconnection may be a transparent electrode interconnection, or a metal interconnection including an anti-reflection layer on a surface thereof in contact with the upper substrate.

The optical amplification cover may be configured in such a manner that infrared light incident on the transparent optical amplification layer meets total internal reflection conditions and is scattered by the fingerprint in contact with the display surface and emitted to the optical sensor array.

According to another aspect of the present invention, there is provided a display apparatus having an image scanning function including a lower substrate portion including a thin film transistor (TFT) array configured to drive a plurality of pixels on an inner side of a lower substrate, an upper substrate portion including a black matrix formed to correspond to an opaque portion of the TFT array and shielding visible light and an optical sensor array disposed to overlap the black matrix on an inner side of an upper surface, and a liquid crystal layer disposed between the lower substrate portion and the upper substrate portion. The black matrix may be formed of an infrared filter resin shielding visible light and transmitting infrared light, and the optical sensor array may include a plurality of infrared sensors. The plurality of infrared sensors may be respectively arranged to two-dimensionally overlap TFTs configured to drive pixel electrodes in the TFT array.

The optical sensor array may include a metal interconnection and an optical sensor disposed on an inner side of the black matrix. In this case, the upper substrate portion may further include an optical waveguide formed in a portion of the black matrix corresponding to the optical sensor, or at least one microlens formed in a portion corresponding to the optical sensor.

Meanwhile, the optical sensor array may include an interconnection and an optical sensor disposed between the upper substrate and the black matrix. In this case, the interconnection may be a transparent electrode interconnection, or a metal interconnection including an anti-reflection layer on a surface thereof in contact with the upper substrate.

According to still another aspect of the present invention, there is provided a display apparatus having an image scanning function including an optical amplification cover, one side of which forms a display surface, configured to amplify an optical pattern generated by a fingerprint of a user in contact with the display surface, a display panel including a thin film transistor (TFT) array configured to drive a plurality of pixels forming an image, and an optical sensor array disposed between the optical amplification cover and the TFT array and configured to sense the optical pattern amplified by the optical amplification cover. The optical sensor array can be integrated with the optical amplification cover, and two-dimensionally overlaps a black matrix of the display panel.

### BRIEF DESCRIPTION OF THE DRAWINGS

The above and other subjects, features, and advantages of the present invention will become more apparent to those of ordinary skill in the art by describing in detail exemplary embodiments thereof with reference to the accompanying drawings, in which:

FIG. 1 shows an example of the use of a mobile device in which a display apparatus having an image scanning function according to an embodiment of the present invention is installed;

FIG. 2 schematically shows a configuration of a display apparatus having an image scanning function according to an embodiment of the present invention;

FIG. 3 schematically shows a configuration of a display apparatus having an image scanning function according to an embodiment of the present invention;

FIG. 4 schematically shows a configuration of a display apparatus having an image scanning function according to an embodiment of the present invention;

FIG. 5 shows an implementation example of a transparent optical amplification layer in FIGS. 2 to 4;

FIG. 6 shows an optical amplification cover in a display apparatus having an image scanning function according to an embodiment of the present invention;

FIG. 7 shows an optical amplification cover in a display apparatus having an image scanning function according to an embodiment of the present invention;

FIG. 8 shows an optical amplification cover in a display apparatus having an image scanning function according to an embodiment of the present invention;

FIG. 9 schematically shows a configuration of a sensor-integrated display panel in a display apparatus having an image scanning function according to an embodiment of the present invention;

FIG. 10 is a partially enlarged view of the sensor-integrated display panel in FIG. 9 in a display surface side;

FIG. 11 is a cross-sectional view taken along line XI-XI in FIG. 10;

FIG. 12 conceptually shows how a display apparatus having an image scanning function according to an embodiment of the present invention senses a fingerprint;

FIG. 13 shows an implementation example of an upper substrate portion in a sensor-integrated display panel according to an embodiment of the present invention;

FIG. 14 shows an implementation example of an upper substrate portion in a sensor-integrated display panel according to an embodiment of the present invention;

FIG. 15 shows an implementation example of an upper substrate portion in a sensor-integrated display panel according to an embodiment of the present invention;

FIG. 16 shows a configuration in which an optical amplification cover is combined with an upper substrate portion of a sensor-integrated display panel in a display apparatus having an image scanning function according to an embodiment of the present invention;

FIG. 17 shows a state of alignment between an optical sensor array combined with an optical amplification cover and a black matrix of an liquid crystal display (LCD) panel in a display apparatus having an image scanning function according to an embodiment of the present invention;

FIG. 18 shows a method of utilizing an optical sensor array as a touch sensor in a display apparatus having an image scanning function according to an embodiment of the present invention;

FIG. 19 is a block diagram of a display apparatus according to embodiments of the present invention;

FIG. 20 shows a circuit diagram of an optical sensor according to a comparative example;

FIG. 21 is a cross-sectional view illustrating a pixel and an optical sensor according to embodiments of the present invention;

FIG. 22 is an enlarged cross-sectional view of a sub-pixel illustrated in FIG. 21 according to an embodiment of the present invention;

FIG. 23 is an enlarged cross-sectional view of the sub-pixel illustrated in FIG. 21 according to another embodiment of the present invention;

FIG. 24 is an enlarged cross-sectional view of the sub-pixel illustrated in FIG. 21 according to still another embodiment of the present invention;

FIG. 25 is conceptual diagrams illustrating a method of scanning a subject by a display apparatus according to an embodiment of the present invention;

FIG. 26 is conceptual diagrams illustrating a method of scanning a subject by a display apparatus according to an embodiment of the present invention;

FIG. 27 is a signal diagram illustrating operations of a gate driver and a source driver while a display apparatus according to an embodiment of the present invention displays an image;

FIG. 28 is a signal diagram illustrating operations of a gate driver and a source driver while a display apparatus according to an embodiment of the present invention scans an object;

FIGS. 29 to 31 are conceptual diagrams illustrating various methods of scanning a subject by a display apparatus according to an embodiment of the present invention;

FIG. 32 shows a configuration of an optical sensor array configured to implement an image scanning function according to an embodiment of the present invention;

FIG. 33 is a circuit diagram illustrating an implementation of a charge sharing scheme of an optical sensor SN illustrated in FIG. 32;

FIG. 34 is a circuit diagram illustrating another implementation of the charge sharing scheme of the optical sensor SN illustrated in FIG. 32;

FIG. 35 is a circuit diagram illustrating a configuration of a charge-sharing optical sensor applicable to a display device according to an embodiment of the present invention;

FIG. 36 is a timing diagram for describing an operation of a charge-sharing optical sensor according to an embodiment of the present invention;

FIG. 37 is a circuit diagram illustrating an implementation of a source follower scheme of the optical sensor SN illustrated in FIG. 32;

FIG. 38 is a circuit diagram illustrating a configuration of a source-follower optical sensor applicable to a display apparatus according to an embodiment of the present invention;

FIG. 39 is a timing diagram for describing an operation of a source-follower optical sensor according to an embodiment of the present invention; and

FIG. 40 is a plan view illustrating a layout of a circuit structure of a source-follower optical sensor according to an embodiment of the present invention.

### DETAILED DESCRIPTION OF EXEMPLARY EMBODIMENTS

Exemplary embodiments of the present invention will be described in detail below with reference to the accompanying drawings. However, the embodiments of the present invention can be implemented in various forms and are not limited to the embodiments disclosed herein. In describing the embodiments of the present invention, detailed descriptions configurations or functions that are well-known in the art will be omitted. The same reference numbers will be used throughout this specification to refer to the same or like components.

Spatially relative terms, such as “upper portion,” “lower portion,” “upper surface,” “lower surface,” and the like may be as illustrated in the drawings, unless described otherwise. In describing a layered structure in the accompanying drawings, a portion closer to a display surface is described as being on an upper side, and the portion opposite thereto is described as being on a lower side.

Throughout the specification, it will be understood that when an element or layer is referred to as being “connected to” or “coupled to” another element or layer, it can be directly connected or coupled to the other element or layer or intervening elements or layers may be present. It will be further understood that the terms “comprises,” “comprising,” “includes,” and/or “including” specify the presence of elements, but do not preclude the presence or addition of one or more other elements.

In addition, an “optical sensor” refers to a sensor device providing an electrical signal according to the intensity of applied light. The optical sensor may include various types of devices, such as photo transistors (photo TFTs) and photodiodes, in point of device configuration, and an infrared sensor or the like as well as a visible light sensor in point of a wavelength band of a detection target.

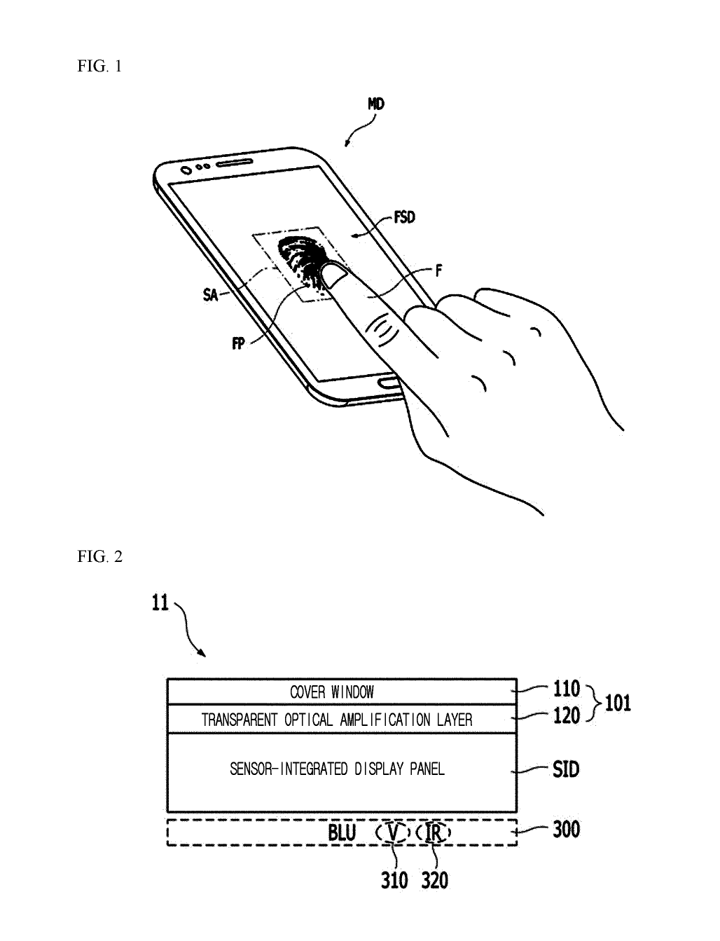

FIG. 1 shows an example of the use of a mobile device in which a display apparatus having an image scanning function according to an embodiment of the present invention is installed.

For example, a mobile device MD may be a digital device having display functions, such as wired/wireless communication, information processing, and media playing, that is, a smartphone, a tablet PC, an electronic book, or a navigator. The mobile device MD may include a variety of flat panel display (FPD) apparatuses, such as an electronic paper (E-Paper) display, a field emission display (FED), or a quantum-dot display, as well as a liquid crystal display (LCD) or an organic light emitting display (OLED). A smartphone will generally be used as an example, but the present invention is not limited thereto. A display apparatus FSD having an image scanning function according to the embodiment of the present invention may be implemented based on the above-described variety of FPD, and employed in any device that requires a display function and a fingerprint sensing function.

The display apparatus FSD having an image scanning function may be formed on a surface of the mobile device MD and preferably formed on a front surface of the mobile device MD as illustrated in FIG. 1, and may function as a display apparatus and an input device such as a touch interface at the same time. The display apparatus FSD having an image scanning function may detect a fingerprint pattern FP from a finger F of a user in contact with a specific area SA of a display surface thereof. The display apparatus FSD having an image scanning function may be implemented by sensing a position in contact with the finger F, then setting the specific area SA according to the position, and then detecting the fingerprint pattern FP from the specific area SA.

Although described later, the display apparatus FSD having an image scanning function according to an embodiment of the present invention may detect the fingerprint pattern FP by sensing an optical pattern generated according to shapes of ridges and valleys of a fingerprint. Accordingly, the display apparatus FSD having an image scanning function may include an optical sensor array having a plurality of optical sensors arranged to have a resolution sufficient to distinguish the ridges and valleys of the fingerprint. The optical sensor array of the display apparatus FSD having an image scanning function may sense light emitted from the display surface and reflected from a surface of the finger F, but may also sense ambient light passing through the finger F and incident to the display surface. For example, the light sensed by the optical sensor array may be non-visible light such as infrared light. By sensing the non-visible light, visible light forming a display image may not affect the fingerprint sensing operation. However, the present invention may not be limited thereto. For example, the optical sensor array may sense visible light.

FIG. 2 schematically shows a configuration of a display apparatus having an image scanning function according to an embodiment of the present invention.

Referring to FIG. 2, a display apparatus 11 having an image scanning function according to an embodiment of the present invention may include a sensor-integrated display panel SID in which an optical sensor array is integrated with a display panel, and an optical amplification cover 101 disposed on the sensor-integrated display panel SID. The optical amplification cover 101, one side of which forms a display surface, includes a transparent optical amplification layer 120 that amplifies an optical pattern generated by a fingerprint of a user in contact with the display surface and a cover window 110 for reinforcement. According to an embodiment of the present invention, the cover window 110 may form the display surface, and the transparent optical amplification layer 120 may be disposed between the cover window 110 and the sensor-integrated display panel SID.

Here, the sensor-integrated display panel SID includes a thin film transistor (TFT) array that drives a plurality of pixels forming an image, and an optical sensor array disposed closer to the optical amplification cover 101 than the TFT array and sensing the optical pattern amplified by the optical amplification cover 101. In terms of a configuration for function as a display panel, the sensor-integrated display panel SID may be an active matrix drive type LCD panel or an active matrix drive type OLED panel. Besides the two types of display panels, any display panel having a TFT array that drives a plurality of pixels arranged in a matrix form may be used.

When the sensor-integrated display panel SID is the LCD panel, a separated surface light source, that is, a backlight unit 300 may be disposed thereunder. The backlight unit 300 generally includes a light source 310 emitting visible light, but may further include a light source 320 emitting infrared light as needed.

The cover window 110 may be formed of tempered glass, which is usually applied to an upper surface of a touchscreen of a smartphone, or a transparent material having strength and hardness corresponding thereto.

The transparent optical amplification layer 120 may serve to increase the amount of light received by the optical sensor array through wavelength conversion or polarization conversion, or additionally supply light through internal total reflection in order to sense a fingerprint. Specific configurations and functions of the transparent optical amplification layer 120 will be described later with reference to embodiments in which various types of transparent optical amplification layers are applied.

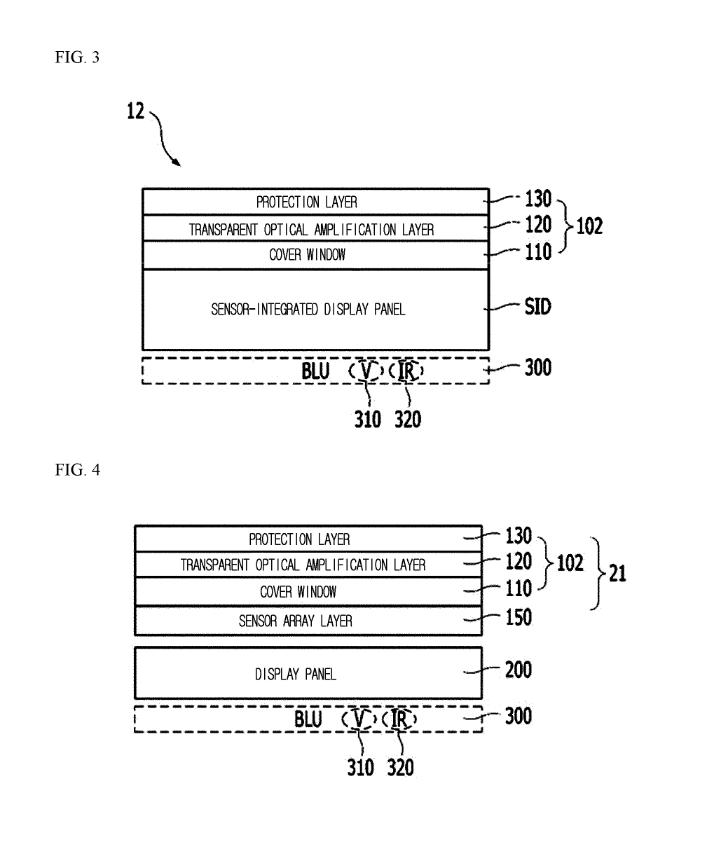

FIG. 3 schematically shows a configuration of a display apparatus having an image scanning function according to an embodiment of the present invention.

A display apparatus 12 having an image scanning function according to an embodiment of the present invention is the same as that according to the embodiment illustrated in FIG. 2, except the configuration of an optical amplification cover 102. The optical amplification cover 102 may include a cover window 110, a transparent optical amplification layer 120 formed on the cover window 110, and a protection layer 130 formed on the transparent optical amplification layer 120. A surface of the protection layer 130 forms the above-described display surface. Here, the protection layer 130 is a transparent coating layer having a greater hardness than the transparent optical amplification layer 120. For example, the protection layer 130 may be formed of glass, silicon oxide, silicon nitride, a transparent oxide, polymer thin film, or a polymer film.

FIG. 4 schematically shows a configuration of a display apparatus having an image scanning function according to an embodiment of the present invention.

In an optical amplification cover 102 having a configuration as described in the embodiment of FIG. 3, a sensor array layer 150 having an optical sensor array is integrally formed on a lower surface of the cover window 110 to form a fingerprint-sensing module 21 including the optical amplification cover 102, and the fingerprint-sensing module 21 is disposed on a display panel 200. The display panel 200 may be various types of FPD panels, such as an E-Paper display, a FED, or a quantum-dot display, as well as an LCD or an OLED. When the display panel 200 is an LCD panel, the display apparatus may further include a backlight unit 300 having a visible light source 310 under the display panel 200. The backlight unit 300 may further include an infrared light source 320 as needed.

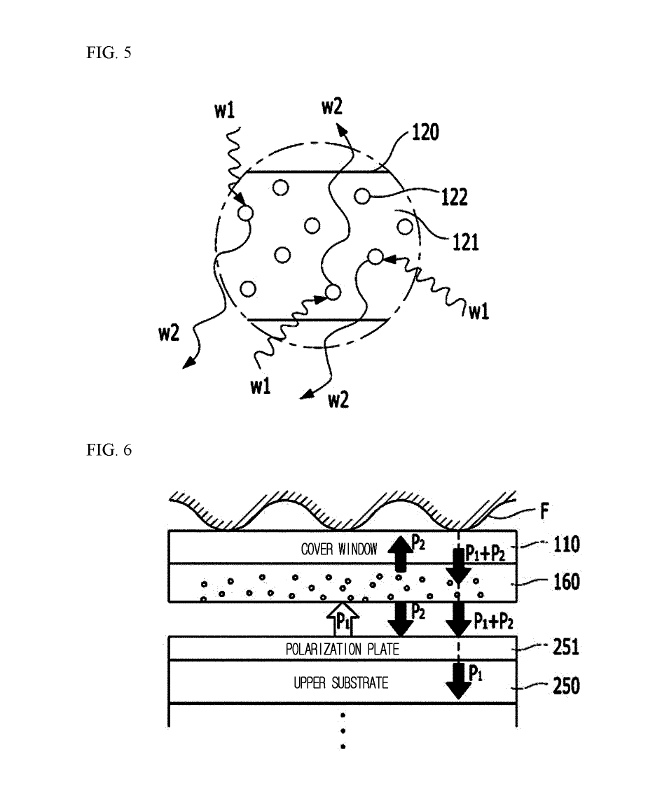

FIG. 5 shows an implementation example of a transparent optical amplification layer in FIGS. 2 to 4.

In the above-described embodiments, the transparent optical amplification layer 120 may include a transparent medium 121 and a plurality of quantum dots 122 distributed in the transparent medium 121. The plurality of quantum dots 122 are a type of nanostructures having core-shell structures and having diameters of several nanometers, may be formed of a variety of materials, and may have a variety of sizes. The plurality of quantum dots 122 may absorb light of a specific wavelength band and emit light of a different wavelength band according to the type and size of the material thereof.

Accordingly, the transparent optical amplification layer 120 including the plurality of quantum dots 122 may absorb light w1 of a first wavelength band, convert it to light w2 of a second wavelength band, and emit the light w2 of the second wavelength band. For example, the light w1 of the first wavelength band may be light of a visible wavelength band, and the light w2 of the second wavelength band may be light of an invisible wavelength band. More specifically, the light w1 in the first wavelength band may be blue light, and the light w2 in the second wavelength band may be infrared light. For another example, both of the first wavelength band and the second wavelength band may belong to the infrared band. Usually, a high-energy wavelength is converted into a low-energy wavelength, and a low-energy wavelength may be converted into a high-energy wavelength (so called, up-conversion) using an additional structure (quantum dots, a catalyst, or the like). Here, the light w2 of the second wavelength band is preferably light of a wavelength band sensed by the plurality of optical sensors included in the above-described optical sensor array.

Since the transparent optical amplification layer 120 is disposed on a path where light emitted from the display panel (hereinafter, referred to as display light) proceeds toward the user, the transparent optical amplification layer 120 is preferably a material that does not have an effect on the display light. However, when infrared light separate from the display light is not emitted from an OLED panel or a backlight unit disposed on the back of an LCD panel, the transparent optical amplification layer 120 may be preferably utilized in fingerprint sensing by partially absorbing blue light and converting the absorbed blue light into infrared light so as to have the least effect on color reproducibility of the display panel.

FIG. 6 shows an optical amplification cover in a display apparatus having an image scanning function according to an embodiment of the present invention.

The optical amplification cover according to an embodiment of the present invention may include a cover window 110 configured to be in contact with a finger F of a user, and a transparent optical amplification layer 160 having a polarization converting function. The transparent optical amplification layer 160 may include a polarization-converting layer which converts first polarized light P1 to second polarized light P2 having a polarization axis substantially perpendicular to a polarization axis of the first polarized light P1. The transparent optical amplification layer 160 may include a polarization-converting layer in which a plurality of quantum dots having the polarization converting function are distributed in a transparent medium. The transparent optical amplification layer 160 may be configured only with a single polarization-converting layer or through a combination of the polarization-converting layer and another layer.

In terms of functions of the transparent optical amplification layer 160 having the polarization conversion function, the transparent optical amplification layer 160 may absorb the first polarized light P1 passing through a polarization plate 251 disposed on an upper surface of an upper substrate 250 of the LCD panel, for example, and emit the second polarized light P2 having the polarization axis substantially perpendicular to the polarization axis of the first polarized light P1. The transparent optical amplification layer 160 emits the converted second polarized light P2 downwardly as well as toward the cover window 110. Since the second polarized light P2 emitted downwardly is shielded by the polarization plate 251, it does not affect the optical sensor array disposed under the upper substrate 250. Meanwhile, the second polarized light P2 emitted toward the cover window 110 is reflected by the finger F in contact with a surface of the cover window 110 and converted again into light in which the first polarized light P1 and the second polarized light P2 are mixed, and the first polarized light P1 of the light passes through the polarization plate 251 to be transferred to the optical sensor array disposed under the upper substrate 250. In this manner, a ratio of noise with respect to a fingerprint pattern signal detected in the optical sensor array may be reduced.

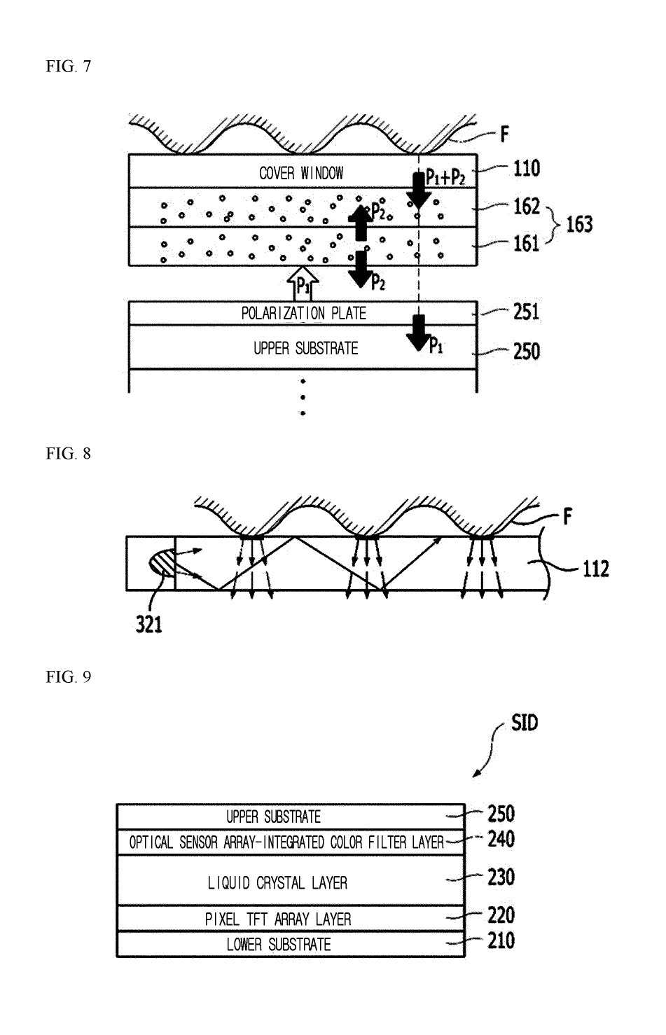

FIG. 7 shows an optical amplification cover in a display apparatus having an image scanning function according to an embodiment of the present invention.

In the optical amplification cover according to an embodiment of the present invention, a transparent optical amplification layer 163 may be configured to include a first transparent optical amplification layer 161, which is the polarization-converting layer described in the embodiment of FIG. 6, and a second transparent optical amplification layer 162 disposed between a cover window 110 and the first transparent optical amplification layer 161. The second transparent optical amplification layer 162 may not affect a polarization axis of light, similarly to the transparent optical amplification layer having the wavelength-converting function described in the embodiment of FIG. 5. In this case, effects in which the polarization-converting effect according to the embodiment of FIG. 6 is added to the wavelength-converting effect according to the embodiment of FIG. 5 may be obtained due the transparent optical amplification layer 163.

FIG. 8 shows an optical amplification cover in a display apparatus having an image scanning function according to an embodiment of the present invention.

According to an embodiment of the present invention, the optical amplification cover may include a transparent optical amplification layer 112 having a function of a light guide plate. In the optical amplification cover, infrared light incident on the transparent optical amplification layer 112 to satisfy internal total reflection is scattered by a fingerprint of a finger F in contact with the display surface and emitted toward the optical sensor array disposed opposite to the display surface. In this regard, an infrared light source 321 may be disposed on at least one side end of the transparent optical amplification layer 112. Meanwhile, the transparent optical amplification layer 112 having the light guide plate function may be the above-described cover window or an additional layer combined with the cover window.

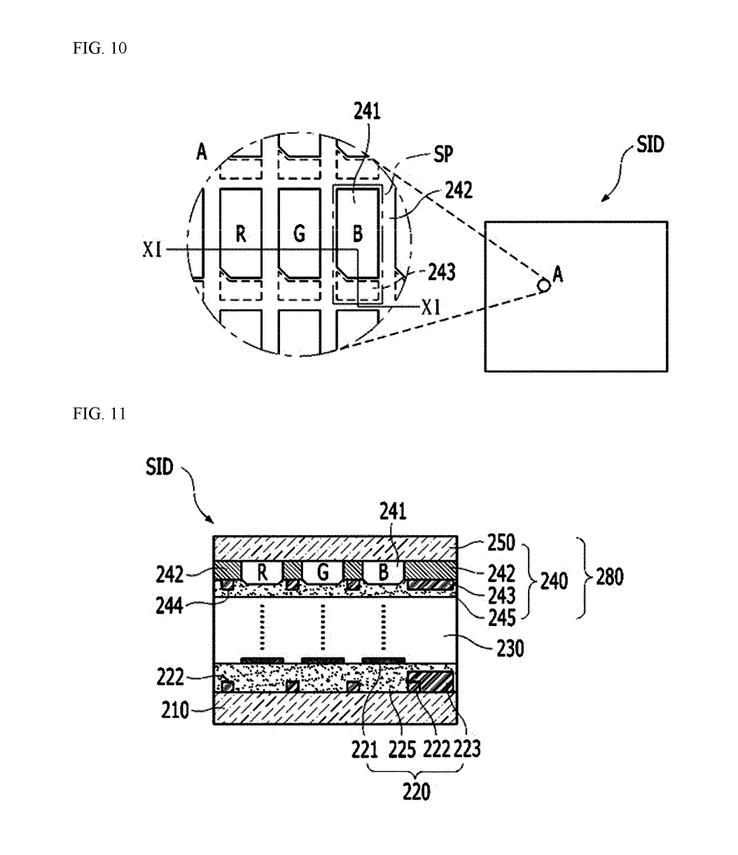

FIG. 9 schematically shows a configuration of a sensor-integrated display panel in a display apparatus having an image scanning function according to an embodiment of the present invention. FIG. 10 is a partially enlarged view of the sensor-integrated display panel in FIG. 9 in a display surface side.

According to an embodiment of the present invention, the sensor-integrated display panel SID may be, for example, an LCD panel with which an optical sensor array is integrated. The sensor-integrated display panel SID includes an upper substrate 250, a lower substrate 210, and a liquid crystal layer 230 sealed therebetween, as illustrated in FIG. 9. A pixel TFT array layer 220 including a TFT array driving a plurality of pixels is formed at an inner side of the lower substrate 210.

A color filter array corresponding to the plurality of pixels is formed at an inner side of the upper substrate 250. The color filter array includes a plurality of light-transmitting parts 241 which selectively transmit light of a specific color, such as red(R), green (G), or blue (B), and a black matrix 242 shielding light between the plurality of light-transmitting parts 241 in the form of a matrix. The black matrix 242 is formed to correspond to an opaque portion of the TFT array disposed on the lower substrate 210. The opaque portion of the TFT array includes metal interconnections, such as data lines and gate lines, and pixel-driving TFTs disposed at interconnections between the metal interconnections and driving corresponding pixel electrodes according to electrical signals.

According to an embodiment of the present invention, the optical sensor array is disposed to overlap the black matrix 242 to form a color filter layer 240 integrated with the optical sensor array, and the optical sensor array may be disposed below the black matrix 242 as an example of overlapping. The optical sensor array includes a plurality of optical sensors 243 corresponding to a plurality of sub-pixel areas SP, and a sensor-driving circuit formed in the form of a matrix to drive and read out a sensed signal from the plurality of optical sensors 243. Here, the plurality of optical sensors 243 may have a TFT structure, a diode structure, or an organic thin film sensor structure. Although not shown in the drawings, the sensor-driving circuit may further include a TFT as a switching device, in addition to the metal interconnections and the plurality of optical sensors 243.

FIG. 11 is a cross-sectional view taken along line XI-XI in FIG. 10.

With the liquid crystal layer 230 as a center, the lower substrate 210 and the pixel TFT array layer 220 formed on the lower substrate 210 may be disposed under the liquid crystal layer 230. The pixel TFT array layer 220 includes metal interconnections 222, that is, data lines and gate lines arranged to cross each other, an insulating layer 225, pixel electrodes 221, and pixel-driving TFTs 223. Actually, the gate lines and the data lines are formed in different layers with an insulating layer therebetween, and the pixel-driving TFTs 223 have a structure in which metal electrodes, an insulating layer, semiconductor channels, and the like are stacked. However, they are expressed simply in FIG. 11.

On the liquid crystal layer 230, an upper substrate portion 280 including the upper substrate 250 is disposed. The upper substrate portion 280 includes the color filter layer 240 integrated with an optical sensor array at an inner side of the upper substrate 250. The color filter layer 240 integrated with an optical sensor array includes the black matrix 242, metal interconnections 244 overlapped by the black matrix 242 and configuring the optical sensor array, and the optical sensors 243. Meanwhile, the color filter layer 240 integrated with an optical sensor array may further include a planarization layer 245 covering and planarizing the black matrix 242, the metal interconnections 244, and the optical sensors 243. In addition, although not shown in FIG. 11, an orientation layer aligning liquid crystals may be further disposed between the planarization layer 245 and the liquid crystal layer 230, and a common electrode may be further included according to liquid crystal modes.

In the above-described optical sensor array, the metal interconnections 244 configuring a sensor-driving circuit may include a scan line and a readout line intersecting each other. The scan line and the readout line may be formed in different layers with an insulating layer therebetween. Meanwhile, the scan line and the readout line may be disposed in the same layer in some embodiments of the present invention.

Here, the black matrix 242 may be formed of an infrared filter resin shielding visible light and transmitting infrared light. As a result, even though the optical sensor array is disposed in the upper substrate portion 280, the metal interconnections 244 and the like may not be visually sensed from above the display surface. In addition, the optical sensors 243 may receive light incident from the display surface, for example, light reflected by a fingerprint or the like, without passing through the liquid crystal layer 230. In this manner, sensing sensitivity to an optical pattern generated by the fingerprint may be improved.

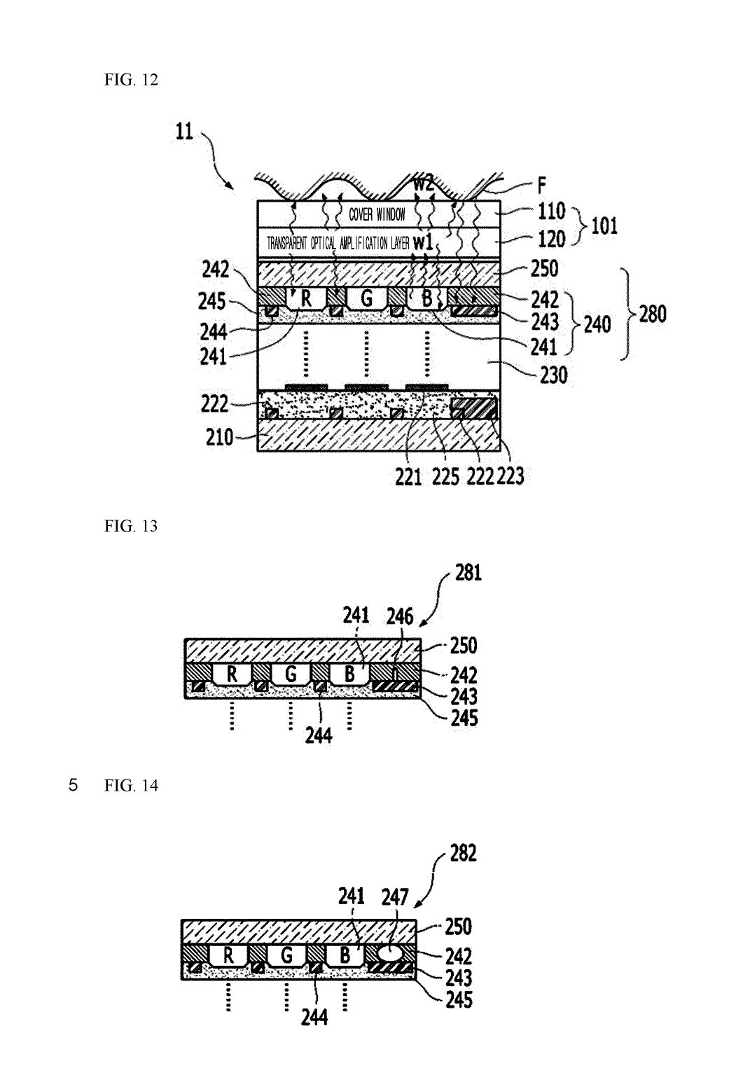

FIG. 12 conceptually shows how a display apparatus having an image scanning function according to an embodiment of the present invention senses a fingerprint.

In a sensor-integrated display panel, display light is emitted upwardly through light-transmitting parts 241 selectively transmitting red (R), green (G), and blue (B) light. A transparent optical amplification layer 120 disposed on an upper substrate 250 partially converts light w1 of a first wavelength band, that is, blue light among the display light, into light w2 of a second wavelength band, that is, infrared light, and emits the converted light w2. The infrared light is reflected in different reflectivity depending on ridges and valleys of a fingerprint of a finger F in contact with a surface of a cover window 110, that is, a display surface, and the reflected light passes through a black matrix 242 formed of an infrared filter resin to be received by optical sensors 243 of an optical sensor array. In this manner, the display apparatus having the image scanning function according to an embodiment of the present invention may provide a function to sense a fingerprint pattern.

An example in which the transparent optical amplification layer 120 in the optical amplification cover 101 has a wavelength-converting function will be described here. However, the configuration of the transparent optical amplification layer 120 and the optical amplification principles are not be limited thereto, and may be implemented in various forms as described with reference to FIGS. 6 to 8.

FIG. 13 shows an implementation example of an upper substrate portion in a sensor-integrated display panel according to an embodiment of the present invention.

As illustrated in FIG. 13, an upper substrate portion 281 includes an upper substrate 250, a color filter array formed on a lower surface of the upper substrate 250 and including light-transmitting parts 241 and a black matrix 242, and an optical sensor array disposed on a lower surface of the black matrix 242 and including metal interconnections 244 and an optical sensor 243. Similar to the above-described embodiment, the black matrix 242 may be formed of an infrared filter resin shielding visible light and transmitting infrared light, and the optical sensor 243 may be an infrared light sensor having high sensitivity with respect to the infrared light. In addition, according to the embodiment illustrated in FIG. 13, the black matrix 242 may further include a light guide 246 formed to further increase light collectivity and light transmittance, such as a slit, a via, or a groove, in a portion corresponding to the optical sensor 243.

As a modified example to which the light guide 246 is applied, the optical sensors 243 may sense visible light, the black matrix 242 may be formed of a material shielding both visible light and infrared light, and the light guide 246 may be transparent to visible light.

A transparent planarization layer 245 is disposed under the above-described optical sensor array. As described above, the planarization layer 245 may serve to planarize a surface through which the upper substrate portion 281 is in contact with a liquid crystal layer, an orientation layer may be further disposed between the planarization layer 245 and the liquid crystal layer 230, and a common electrode layer may be further included.

FIG. 14 shows an implementation example of an upper substrate portion in a sensor-integrated display panel according to an embodiment of the present invention.

A difference from the embodiment of FIG. 13 is that the black matrix 242 has a microlens 247 instead of the light guide 246 in a portion corresponding to the optical sensor 243. The microlens 247 may collect a larger amount of light to provide the light to the optical sensors 243.

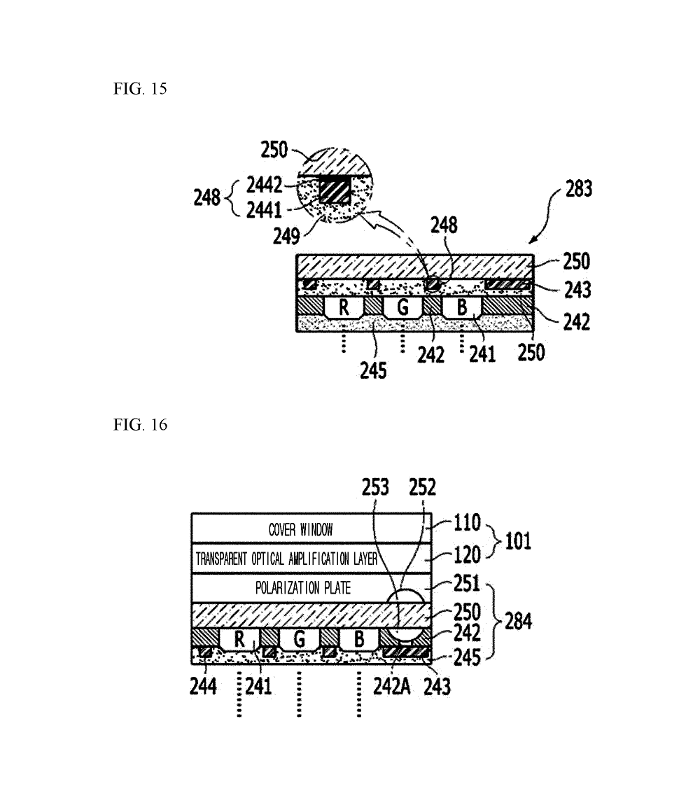

FIG. 15 shows an implementation example of an upper substrate portion in a sensor-integrated display panel according to an embodiment of the present invention.

As illustrated in FIG. 15, in an upper substrate portion 283, an optical sensor array including interconnections 248 and optical sensors 243 may be disposed at an inner side of an upper substrate 250, and a color filter array including the above-described light-transmitting parts 241 and a black matrix 242 may be disposed under the optical sensor array. A planarization layer 249 may be disposed between the optical sensor array and the color filter array.

In this case, the interconnections 248 may be formed of a transparent electrode material, and the optical sensors 243 may also be devices using an optically transparent oxide semiconductor. When the interconnections 248 are metal interconnections, the interconnections 248 may include an anti-reflection layer 2442 between a metal layer 2441 and the upper substrate 250 to prevent external light reflected by a metal from degrading display image quality. The anti-reflection layer 2442 may be formed of, for example, a black-colored metal oxide, in a process of, for example, depositing the metal layer 2441. In this case, since the optical sensor array is disposed higher than the color filter array, a material applied to a normal LCD panel may be used as a material of the black matrix 242.

FIG. 16 shows a configuration in which an optical amplification cover is combined with an upper substrate portion of a sensor-integrated display panel in a display apparatus having an image scanning function according to an embodiment of the present invention.

Although not specifically described in the embodiments of FIGS. 9 to 15, when the sensor-integrated display panel is based on an LCD panel, a polarization plate 251 is commonly disposed on an upper substrate 250, that is, between the upper substrate 250 and the optical amplification cover 101.

According to an embodiment of the present invention, a plurality of microlenses 252 and 253 may be disposed on and below the upper substrate 250. The plurality of microlenses 252 and 253 may be disposed in portions corresponding to an optical sensor 243 disposed below the black matrix 242. The plurality of microlenses 252 and 253 may collect light on the optical sensor 243 through an opening 242A formed in the black matrix 242, and a focal length may be effectively adjusted using an optical system formed of the plurality of microlenses 252 and 253.

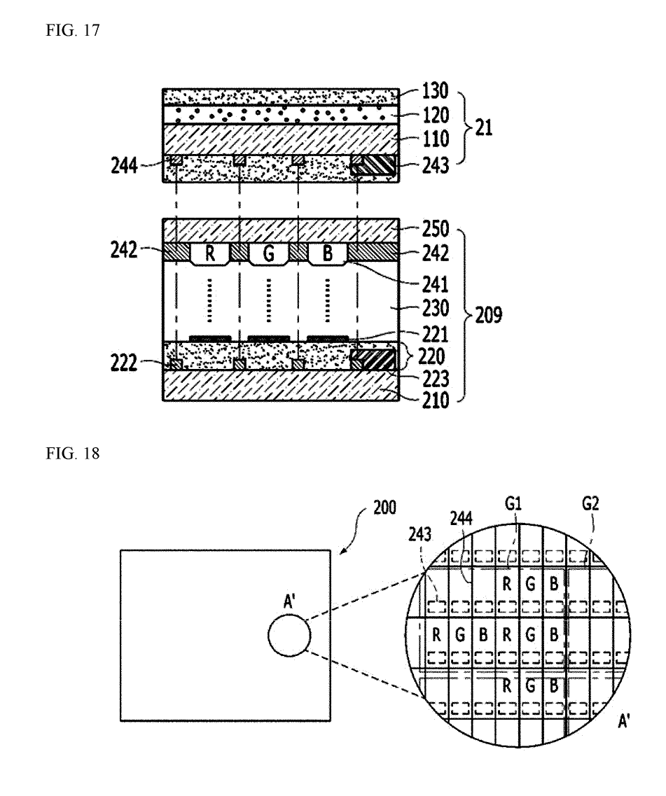

FIG. 17 shows a state of alignment between an optical sensor array combined with an optical amplification cover and a black matrix of an LCD panel in a display apparatus having an image scanning function according to an embodiment of the present invention.

As illustrated in FIG. 17, the display apparatus having the image scanning function according to an embodiment of the present invention has a layered structure as shown in the above-described embodiment of FIG. 4. That is, the display apparatus includes a fingerprint-sensing module 21 in which an optical sensor array including interconnections 244 and an optical sensor 243 is disposed under an optical amplification cover configured with a protection layer 130, a transparent optical amplification layer 120, and a cover window 110 from the top, and the fingerprint-sensing module 21 is disposed to be aligned with and overlap an LCD panel 209.

In FIG. 17, the interconnections 244 and optical sensor 243 of the optical sensor array belonging to the fingerprint-sensing module 21 are aligned and overlapped with a black matrix 242 formed at an inner side of an upper substrate 250 of the LCD panel 209, and with metal interconnections 222 and a pixel-driving TFT 223 of a TFT array formed at an inner side of a lower substrate 210 of the LCD panel 209, in a top view. A plurality of light-transmitting parts 241, which are color filters transmitting monochromatic light of red (R), green (G), or blue (B), are disposed on a plurality of pixel electrodes 221, and portions overlapping the plurality of light-transmitting parts 241 in the fingerprint-sensing module 21 are optically transparent. Accordingly, when a user looks down from above a display surface, the optical sensor array of the fingerprint-sensing module 21 may not affect a resolution of the display apparatus.

The optical amplification cover according to an embodiment of the present invention includes a transparent optical amplification layer 120 as described in the embodiment of FIG. 5, but is not limited thereto. The optical amplification cover according to an embodiment of the present invention may be replaced with the optical amplification cover having the configuration described with reference to FIGS. 6 to 8.

FIG. 18 shows a method of utilizing an optical sensor array as a touch sensor in a display apparatus having an image scanning function according to an embodiment of the present invention.

FIG. 18 is an enlarged view of a portion A′ of an optical sensor array in an SID apparatus. Interconnections 244 arranged in the form of a matrix provides a plurality of sub-pixel areas comparted by a plurality of horizontal lines (scan lines) and vertical lines (readout lines, etc.) intersecting each other, and a light-transmitting portion selectively transmitting red (R), green (G), or blue (B) light and an optical sensor 243 are disposed in each sub-pixel area. Since one optical sensor 243 is disposed in each sub-pixel, the sub-pixel may be regarded as one sensing pixel. When a fingerprint is sensed using the display apparatus having the image scanning function according to an embodiment of the present invention, the optical sensor array may readout an electrical signal by the unit of a sub-pixel, that is, by each sensing pixel, and thereby detect a high resolution fingerprint pattern.

The above-described optical sensor array may also function as a touch sensor. Since the optical sensor does not require high resolution when it is utilized as the touch sensor, the optical sensor array may be driven by grouping a plurality of sensing pixels. For example, by performing scanning and readout processes by a plurality of sensing pixel groups, such as a first sensing pixel group G1 and a second sensing pixel group G2, power consumption and time required for touch-sensing may be reduced.

Hereinafter, in a display apparatus integrated with an optical sensor array including a plurality of optical sensors according to an embodiment of the present invention, a method of scanning an object disposed on a display surface, such as a fingerprint of a user, will be described with reference to some cases, in detail.

The display apparatus according to an embodiment of the present invention includes a cell array and a peripheral circuit. The cell array includes a plurality of pixels consisting of at least two sub-pixels arranged in rows and columns and emitting light having different colors, and optical sensors, each of which is disposed adjacent to each sub-pixel or each pixel. The peripheral circuit performs a scanning operation in a scan mode by inducing the pixels to sequentially emit light according to a predetermined pattern and the optical sensors to sense reflected light.

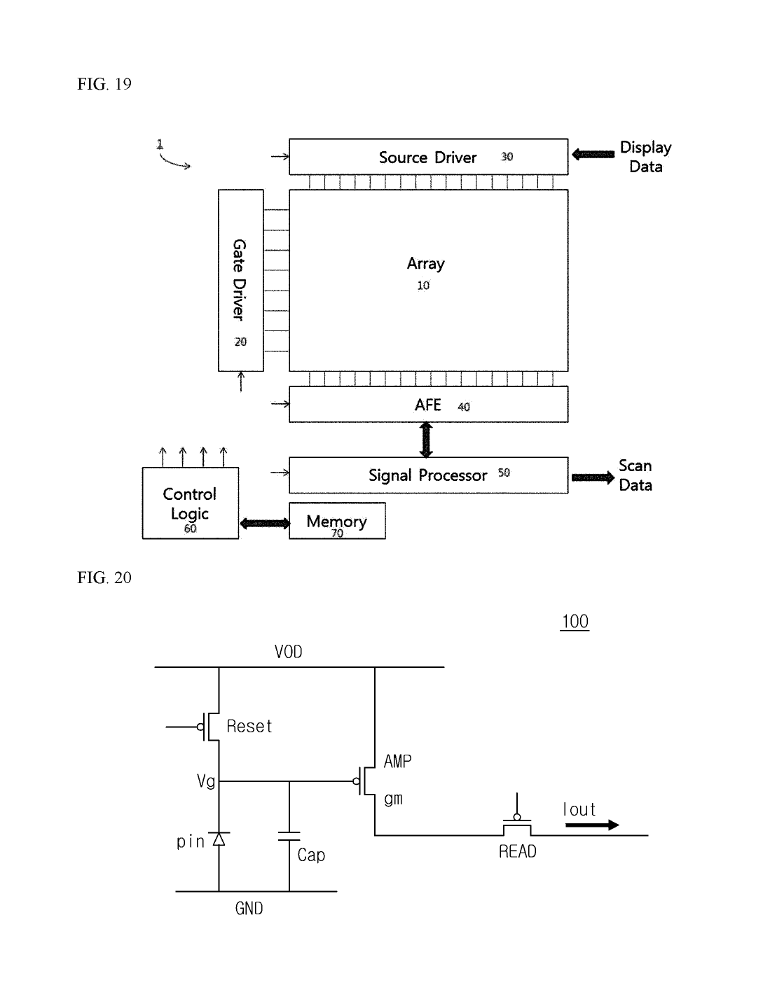

The pixels are spaced apart from each other at a predetermined interval so that the optical sensor of each pixel is not affected by light emitted from another pixel adjacent thereto, to emit light according to the predetermined pattern. FIG. 19 is a block diagram of a display apparatus according to embodiments of the present invention.

Referring to FIG. 19, a display apparatus 1 may display an image or sense a touch of a subject, such as a human finger or a touch pen. The display apparatus 1 may be implemented in a desktop computer, a laptop computer, a tablet PC, or a mobile device such as a smartphone.

The display apparatus 1 includes a cell array 10, a gate driver 20, a source driver 30, an analog front end (hereinafter, AFE) 40, a signal processor 50, a control logic 60, and a memory 70.

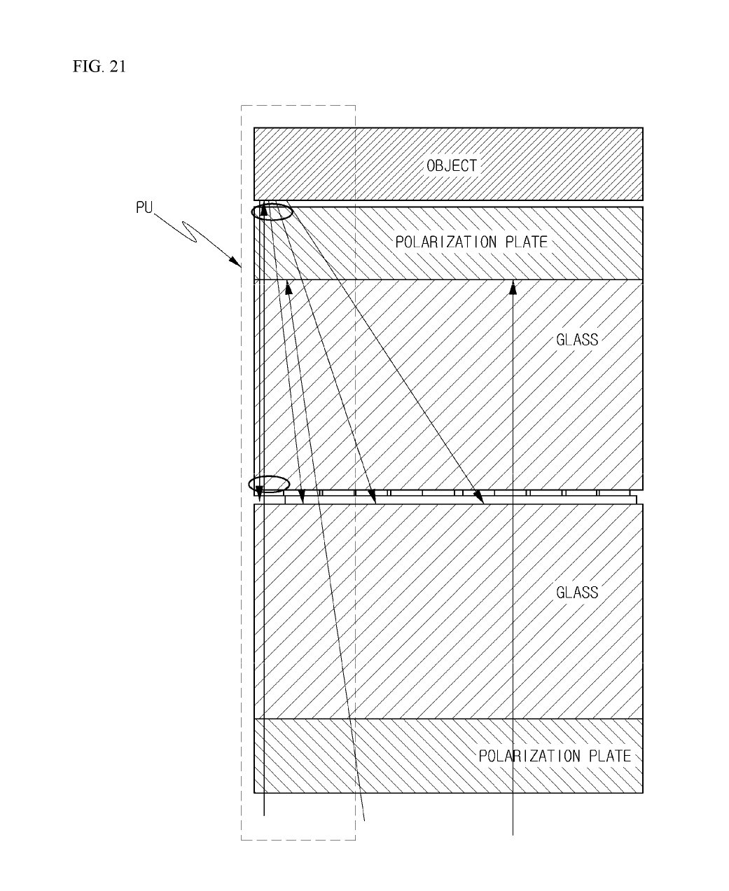

The cell array 10 includes a plurality of unit pixels arranged in a plurality of rows and columns, and unit optical sensors, each of which is adjacent to each unit pixel. Each unit pixel displays an image according to light emitted from a backlight unit. Each optical sensor senses light emitted from the unit pixel and reflected by the subject, and scans a surface of the subject. The unit pixel and the optical sensor will be described with reference to FIG. 21 in detail.

The gate driver 20 accesses each unit pixel or optical sensor included in the cell array 10 by row. The gate driver 20 sequentially enables each row when displaying an image. The gate driver 20 sequentially enables two or more rows according to a predetermined pattern when scanning a subject.

The source driver 30 is connected to each unit pixel included in the cell array 10, and enables all of the columns to output an image when receiving image data. The output image may be updated on a frame-by-frame basis.

The AFE 40 is connected to each optical sensor included in the cell array 10, and, when scanning the subject, sequentially enables two or more columns according to the predetermined pattern, senses light reflected from the surface of the subject, and outputs the reflected light as scanning data. The AFE 40 may include a sample and hold circuit, an analog-to-digital converting circuit, or the like.

The signal processor 50 processes the scanning data received from the AFE 40 to be output to a host.

The control logic 60 controls each component. That is, the control logic 60 controls operations of the gate driver 20, the source driver 30, the AFE 40, and the signal processor 50. The control logic 60 may control the operation of each component based on information stored in the memory 70.

The memory 70 stores information required to operate the display apparatus 1. For example, the memory 70 may store pattern information for an enabling operation of the gate driver 20, the source driver 30, or the AFE 40, interruption information, or the like. In addition, the memory 70 may store information registered based on the scanning data, for example, fingerprint information.

FIG. 20 shows a circuit diagram of an optical sensor according to a comparative example.

Referring to FIG. 20, an optical sensor 100 included in a cell array 10 includes a plurality of transistors (Reset, AMP gm, READ), a photodiode (pin), and a capacitance (Cap).

The optical sensor 100 includes a reset transistor (Reset) connected to a supply voltage (VDD) terminal, the photodiode (pin) connected between the reset transistor (Reset) and a ground voltage (GND) terminal, an amplification transistor (AMP gm) whose gate is connected to an end of the reset transistor (Reset), a parasitic capacitance (Cap) generated between the end of the reset transistor (Reset) and the ground voltage (GND) terminal, and an output transistor (READ) connected to the amplification transistor (AMP gm) and a drain terminal.

When the gate driver 20 is enabled, the optical sensor 100 resets the photodiode (pin) through the reset transistor (Reset) and then receives light reflected from a subject for a predetermined time. The received reflected light is converted to an electrical signal in the photodiode (pin), amplified by gm times through the amplification transistor (AMP gm), and output as sensing data (Iout) through the output transistor (READ) when a read-out enable signal is applied. Further details thereof may be the same as that of known optical sensor technology.

FIG. 21 is a cross-sectional view illustrating a unit pixel and a unit optical sensor according to embodiments of the present invention.

Referring to FIG. 21, the unit pixel has a laminated structure in which a circuit board(not shown), a backlight unit (not shown) formed on the circuit board, a polarization plate and glass formed on the backlight unit, a liquid crystal formed on the glass, a color filter, a cover glass, and a polarization plate are sequentially stacked. Since the laminated structure is implemented by known technology, detailed description thereof will be omitted and parts related to the present invention will be the focus of the following discussion.

When an image is displayed, light emitted from the backlight unit passes through the polarization plate, the glass, and the color filter. The color filter filters the light emitted from the backlight unit to transmit a specific color. For example, an R filter transmits red light, a G filter transmits green light, and a B filter transmits blue light. The image is displayed on a display screen by a combination of red light, green light, and blue light. That is, the unit pixel is composed of sub-pixels of the R filter, the G filter, and the B filter. In addition, each unit pixel may further include a TFT disposed between a lower end of each of the R filter, the G filter, and the B filter and the glass. Here, a gate driver 20 and a source driver 30 sequentially enable a cell array 10 and output an output image on a frame-by-frame basis.

When a subject, such as a finger or a touch pen, is scanned, light emitted from the backlight unit and passing through the polarization plate, the glass, the color filter, the glass, and the polarization plate is reflected on a surface of the subject and incident on an optical sensor adjacent to the TFT via the polarization plate and glass disposed on a surface of the display apparatus. The optical sensor converts the reflected light into an electrical signal to be output as scanning data, as illustrated in FIG. 2. Here, the optical sensor is connected to the gate driver 20 and the AFE 40, and sequentially enabled in the cell array 10 in a predetermined pattern to output the scanning data.

More specifically describing the scanning operation, the optical sensor is disposed adjacent to every sub-pixel, and when one optical sensor is enabled, optical sensors adjacent thereto within a predetermined minimum distance are disabled. The light emitted from the backlight unit passes through a color filter adjacent to the enabled optical sensor to be emitted to the subject. The light reflected from the subject is received by the optical sensor below the color filter and converted to the scanning data to be output. Here, the TFTs of the sub-pixels adjacent to the enabled optical sensor within the predetermined minimum distance may need to be disabled. This is to more accurately sense the reflected light by reducing light interfering in the enabled optical sensor.

In addition, a surface of the glass substrate disposed on the unit pixels of the cell array 10 may further include an embossed shape. In other words, by implementing a convex lens shape on the optical sensor, the reflected light may be collected more whenever the optical sensor is enabled.

In addition, a surface of the polarization plate disposed on the unit pixels of the cell array 10 may also include a convex lens, or may be implemented to have an embossed shape. The convex lens of the surface of the polarization plate in contact with the subject may induce the light reflected from the subject to be collected to the optical sensor.

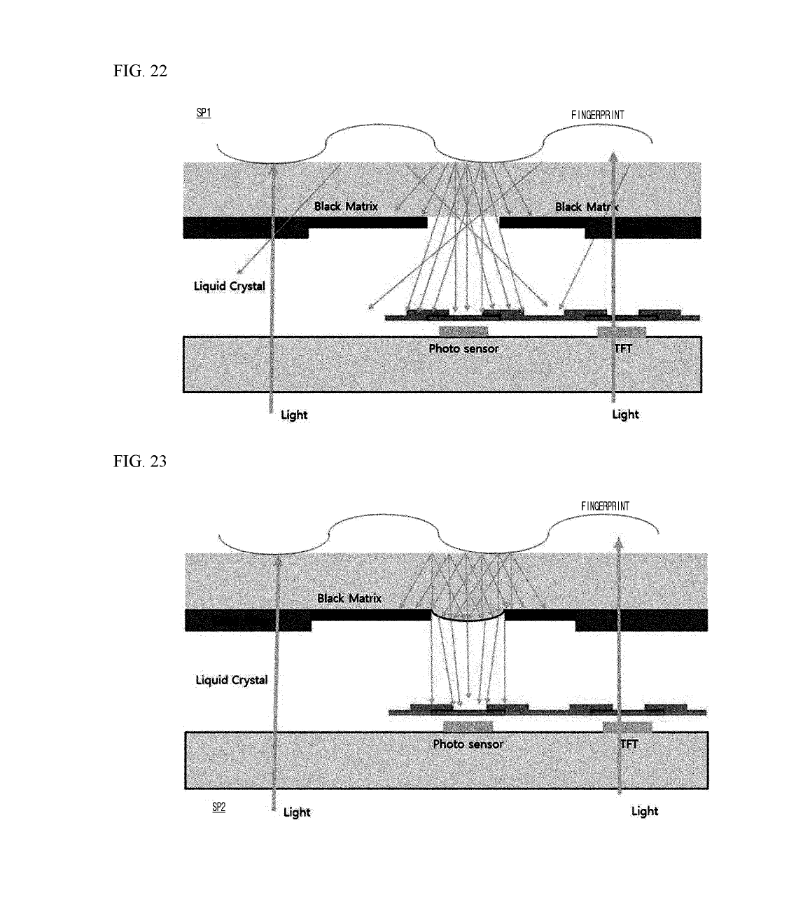

FIG. 22 is an enlarged cross-sectional view of a sub-pixel illustrated in FIG. 21 according to an embodiment of the present invention.

Referring to FIG. 22, a sub-pixel SP1 includes a lower glass substrate, an optical sensor, a TFT, a liquid crystal layer, color filters, a black matrix (hereinafter, BM), and an upper glass substrate.

The optical sensor and the TFT may be disposed in the same plane on the lower glass substrate. However, the present invention may not be limited thereto, and the optical sensor may be disposed on or below the TFT. For convenience an example in which the optical sensor and the TFT are formed in the same plane will be the focus of the following description.

The liquid crystal layer is disposed on the optical sensor and the TFT, and the color filters and the BM are disposed in the same plane on the liquid crystal layer. The BM is disposed between the color filters, that is, between an R filter, a G filter, and a B filter. The BM portions may include an open window for intensively collecting light reflected from the subject while eliminating interference light through a polarization plate or glass.

The TFT may be disposed under the color filter, and may activate the liquid crystal layer to output light emitted from a backlight unit on a display screen. Here, only the enabled TFT is activated to emit light through the color filter, and the adjacent TFTs are disabled to prevent generation of unnecessary interference light and scattering of the reflected light.

The optical sensor adjacent to the enabled TFT is disposed below the open window to receive and sense only the light passing through the open window.

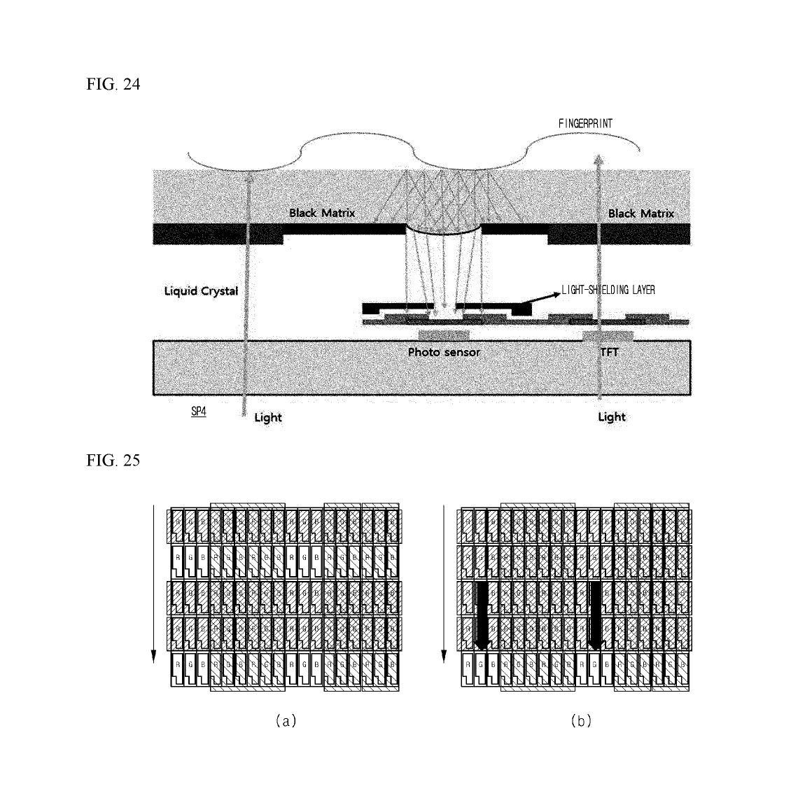

FIG. 23 is an enlarged cross-sectional view of a sub-pixel illustrated in FIG. 21 according to another embodiment of the present invention, and FIG. 24 is an enlarged cross-sectional view of a sub-pixel illustrated in FIG. 21 according to still another embodiment of the present invention. For convenience, features different from those illustrated described in FIG. 22 will be the focus of the following description.

Referring to FIGS. 23 and 24, an upper glass substrate of a sub-pixel SP2 may include an embossing structure corresponding to an open window and functioning as a convex lens.

When the embossing structure is formed at the open window, incident light may be concentrated more in a light-receiving area of the optical sensor without being scattered out of the optical sensor, as illustrated in FIGS. 23 and 24.

Referring to FIGS. 23 and 24, an optical sensor of a sub-pixel SP3 may further include a light-shielding layer. An open area of the light-shielding layer may be smaller than the open window, and a little greater than the light-receiving area of the optical sensor. In this case, light scattered from the liquid crystal layer or adjacent sub-pixels may be shielded by the light-shielding layer, and the light-receiving area of the optical sensor may receive only reflected light incident through the open window.

That is, according to an embodiment of the present invention, a light-receiving efficiency of the optical sensor may be increased by implementing at least one of the open window of the BM, the embossing structure of the upper glass substrate, and the light-shielding layer of the optical sensor. As the light-receiving efficiency of the optical sensor increases, object-scanning performance of the display apparatus 1 may be improved.

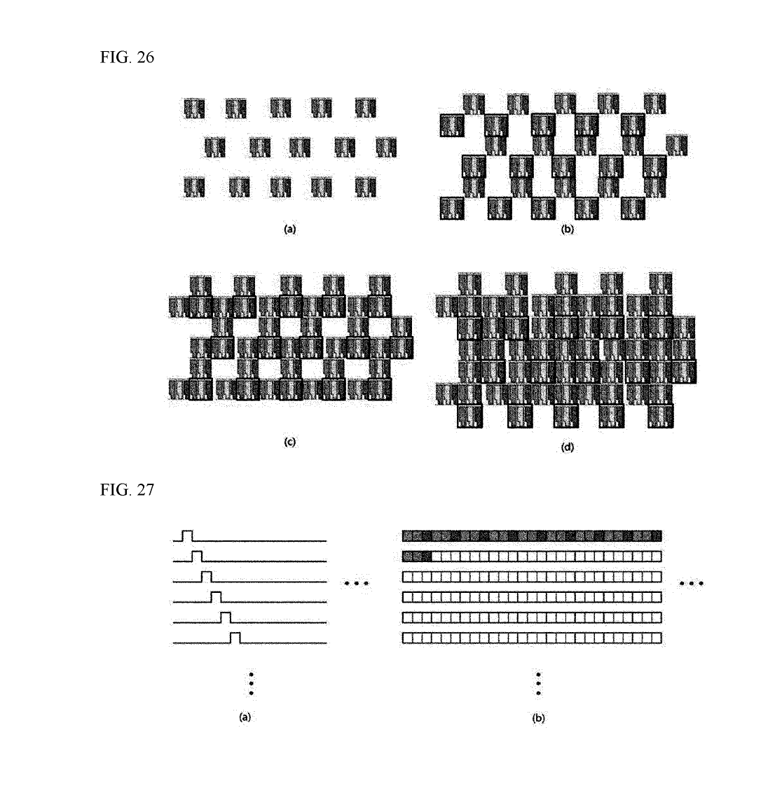

FIGS. 25 and 26 are conceptual diagrams illustrating a method of scanning a subject by a display apparatus according to an embodiment of the present invention.

Referring to FIG. 25, the display apparatus may enable only the pixels arranged at a predetermined interval to emit light to the subject and receive light reflected from the subject. Here, the predetermined interval refers to the minimum distance for light emitted from an enabled pixel not to have an effect of interference light on an optical sensor of an adjacent pixel.

When an image is displayed, the image is output on a frame-by-frame basis by sequentially enabling pixels from (x1,y1) to (x6,y5) in a (6×5) cell array structure. When the subject is scanned, pixels disposed at coordinates (x2,y1) and (x2,y4) in the (6×5) cell array structure are enabled to emit light and receive light reflected from the subject, as illustrated in FIG. 25(a). Next, as illustrated in FIG. 25(b), a second row, a third row, and a fourth row are sequentially scanned according to a corresponding pattern, and pixels disposed at coordinates (x5,y1) and (x5,y4) are enabled to emit light and receive light reflected from the subject. Here, a distance between the pixels disposed at the coordinates (x2,y1) and (x2,y4) is a distance in which the effect of interference light is minimized.

More specifically, first, first pixels emit light according to the pattern having the predetermined interval, and optical sensors of the first pixels receive reflected light (FIG. 26(a)). Next, the first pixels emitting light become disabled, then second pixels marked by a thick line emit light, and then optical sensors of the second pixels receive reflected light (FIG. 26(b)). Similarly, the first and second pixels emitting light become disabled, then third pixels emit light, and then optical sensors of the third pixels receive reflected light (FIG. 26(c)). In the same manner, fourth pixels emit light, and optical sensors thereof receive light (FIG. 26(d)).

In other words, in FIGS. 26(a) to 26(d), the display apparatus sequentially enables pixels in a predetermined pattern and disables the other pixels, and the optical sensors sequentially receive the reflected light. As a result, as illustrated in FIG. 26(d), scanning data may be obtained by receiving the reflected light in the entire display screen, and the scanning data may be stored in a memory with information of a surface of the subject as one frame.

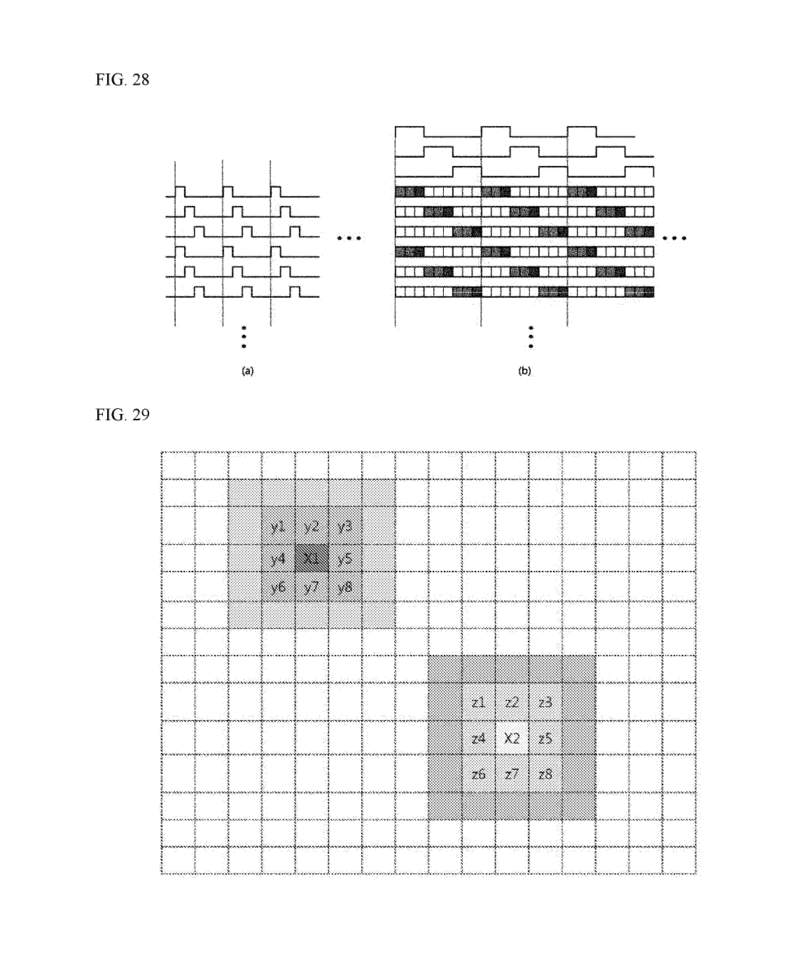

FIG. 27 is a signal diagram illustrating operations of a gate driver and a source driver while a display apparatus according to an embodiment of the present invention displays an image, and FIG. 28 is a signal diagram illustrating operations of a gate driver and a source driver while a display apparatus according to an embodiment of the present invention scans an object.

Referring to FIG. 27(a), in the display operation, the gate driver 20 sequentially enables TFTs in each row of the cell array 10 with no overlap, as known in the art. Referring to FIG. 27(b), the source driver 30 sequentially or simultaneously enables all of the columns to activate RGB pixels and outputs the image on a display screen. Here, until frames of the entire screen are completely output, the gate driver 20 and the source driver 30 do not enable a corresponding row.

Referring to FIG. 28(a), in the scanning operation, the operation of the gate driver 20 and the source driver 30 are different from those of the gate driver 20 and the source driver 30 in FIGS. 27(a) and 27(b).

More specifically, according to the predetermined pattern stored in the memory 70, the gate driver 20 may enable each row at regular intervals even though the frames of the entire screen are not completely input, and simultaneously enable different rows such that enabling periods may overlap.

In addition, the source driver 30 does not enable pixels of all of the columns, and enables them at regular intervals according to the predetermined pattern. Here, the optical sensor may only enable an optical sensor disposed adjacent to the enabled pixel with reference to information about a column enabled by the source driver 30. That is, the pixels and optical sensors of the cell array are enabled according to the predetermined pattern, and thereby a surface image of the subject may be obtained in the predetermined pattern.

As a result, the display apparatus may not only display an image or the like on a display screen, but also obtain information whether the subject is in contact or not and information on a surface of the subject. In addition, the display apparatus according to an embodiment of the present invention have an advantage of being thin since it does not require an electrostatic touchscreen panel to be stacked.

FIG. 29 is a conceptual diagram illustrating another method in which a display apparatus according to an embodiment of the present invention scans a subject.

Referring to FIG. 29, in order to scan a subject, a light source in the display apparatus enables pixels at a predetermined interval and emits light to the subject. Here, the light source refers to not only a self-emitting light source such as a pixel of an OLED display, but also a light source implemented by controlling transmission/blocking and intensity of backlight, such as a pixel of an LCD. Features different from the above-described embodiment of the present invention will be the focus of the following discussion. In this case, all of the optical sensors included in an optical sensor array are enabled.

When all of the optical sensors are enabled, an optical sensor spaced apart by a distance R from the same light source among the optical sensors receive reflected light and scattered light generated by the reflected light. Here, a first optical sensor spaced apart by a predetermined distance f (let's assume f<R) from the light source receives the greatest amount of the reflected light, and second optical sensors disposed around the first optical sensor receive the scattered light generated by the reflected light. That is, a sensing value of the first optical sensor may be greater or smaller than sensing values of the second optical sensors.

For convenience, it is assumed that X1 and X2 illustrated in FIG. 29 are coordinates of the optical sensors spaced apart by a distance in which the influence of the scattered light on each other is minimized. In addition, one frame is defined as performing a scanning operation until all of the light sources are turned on in such a manner that portions of light sources are sequentially turned on at predetermined intervals at which the influence of the scattered light on each other is minimized

For example, when a valley of a fingerprint corresponds to a position X1 and the light source corresponding to X1 is turned on, the optical sensor disposed at X1 receives the least amount of light reflected from the subject since a layer in which the optical sensor is disposed is the farthest from the light source. However, the optical sensors disposed at y1 to y8 in the closest distance from X1 receive a greater amount of scattered light than the optical sensor disposed at Xl. Here, differences in the amount of light received by the optical sensors disposed at X1 and y1 to y8 may be greater when there is no scattered light. However, since scattered light is generated due to a different refractivity of an intermediate medium layer interposed between the optical sensors and the subject, the difference in the amount of the light (referred to as a delta value, hereinafter) between the optical sensor disposed at X1 and the optical sensor disposed at each of y1 to y8 tends to decrease. That is, when the sensing value of the optical sensor at X1 is smaller than an average sensing value of the optical sensors y1 to y8, the display apparatus determines the position as corresponding to the valley of the fingerprint.

For another example, when a ridge of the fingerprint corresponds to a position X2 and the light source corresponding to X2 is turned on, the optical sensor disposed at X2 receives the greatest amount of light reflected from the subject since the optical sensor layer is the closest from the light source. However, the optical sensors disposed at z1 to z8 in the closest distance from X2 receive a smaller quantity of scattered light than the optical sensor disposed at X2. Since scattered light is generated due to a different refractivity of an intermediate medium layer interposed between the optical sensors and the subject, a delta value between the optical sensor disposed at X2 and the optical sensor disposed at each of z1 to z8 tends to decrease. That is, when the sensing value of the optical sensor at X2 is greater than an average sensing value of the optical sensors z1 to z8, the display apparatus determines the positions as corresponding to the ridge of the fingerprint.

In raw partial images extracted according to the above-described embodiments of the present invention, since the peripheral optical sensors (y1 to y8 or z1 to z8) except the optical sensor disposed at the coordinate (X1 or X2) corresponding to the light source are components of the scattered light, the components of the scattered light need to be removed as noise before the raw partial images are combined in a full image. In the case of X2, a noise component may not need to be specifically removed since a blur degree of the raw partial image due to the influence of the scattered light is trivial thanks to the sensing value of the optical sensor corresponding to the ridge of the fingerprint. However, in the case of Xl, since the influence of the scattered light by the valley of the fingerprint is greater than that by the ridge of the fingerprint, light scattered from the intermediate medium layer is additionally incident on the optical sensor disposed at X1 even though only the reflected light is to be incident. Accordingly, the noise component needs to be subtracted from the sensing value at X1. That is, in order to combine a full image, when first raw partial images obtained according to a first light source arrangement and second raw partial images obtained according to a second light source arrangement are combined, the average of the sensing values sensed in the adjacent optical sensors disposed farther than the optical sensors disposed at y1 to y8 is subtracted from the sensing values of optical sensors disposed at X1, and y1 to y8. As a result, the delta value between the ridge of the fingerprint and the valley of the fingerprint becomes sufficient to obtain a more accurate full image.

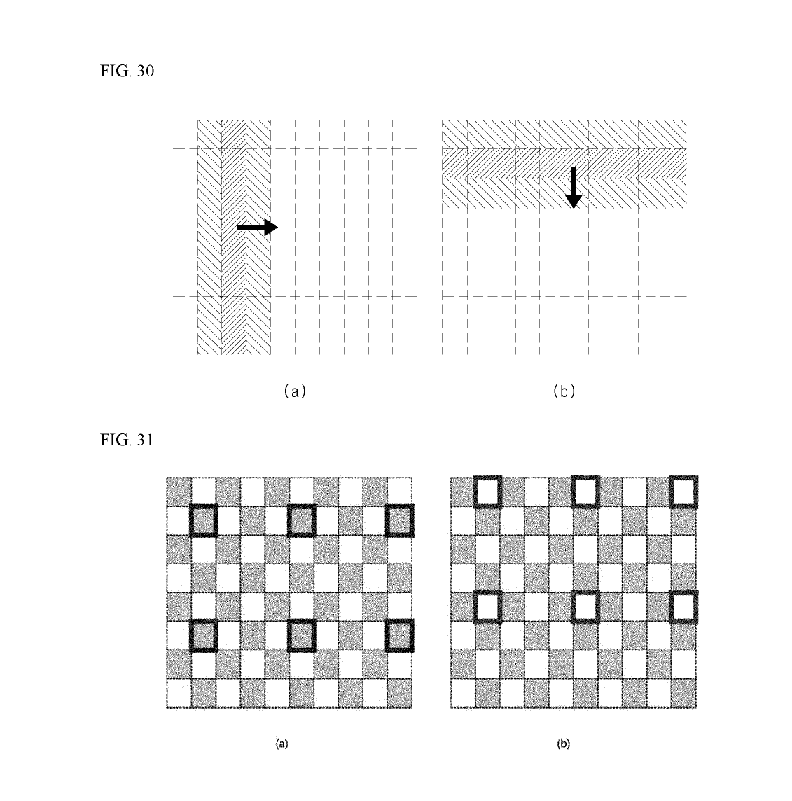

FIG. 30 is a conceptual diagram illustrating another method in which a display apparatus according to an embodiment of the present invention scans a subj ect.

Referring to FIG. 30, the light sources are turned on and scanned line by line. More specifically, the light sources may be sequentially turned on from a first row to an M^{th} row to sense partial images after the light sources are sequentially turned on from a first column to an N^{th} column to sense partial images.

In this case, scattered light between the previous column and the next column may be only considered when the light sources are turned on in a column direction, and scattered light between the previous row and the next row may be only considered when the light sources are turned on in a row direction.

Referring to FIG. 30(a), for example, when assuming that a sensing value at coordinates (x3, y5) in a first partial image sensed while light sources disposed in a third column (x3) are turned on includes values obtained by sensing both of reflected light and scattered light, and a sensing value at coordinates (x3, y5) in a second partial image sensed while light sources disposed in a fourth column (x4) are turned on includes a value only obtained by scattered light, a fingerprint image considering the scattered light may be obtained by subtracting the sensing value of the second partial image from the sensing value of the first partial image. As another example, in order to control an offset of the sensing value of the fingerprint, a value of the scattered light sensed from a distance farther than a coordinate x3 while the third column (x3) are turned on may be subtracted from a sensing value of the coordinate x3 of the second partial image. As still another example, as described above, since the distance between the subject and the optical sensor is greater when the valley of the fingerprint is sensed than when the ridge of the fingerprint is sensed, the influence of the scattered light is significant when the valley of the fingerprint is sensed. Accordingly, the sensing value according to the scattered light may be subtracted only from the sensing values obtained from the position corresponding to the valley of the fingerprint.

In the above-described manner, a fingerprint pattern image considering the scattering light in the row direction may be obtained by sequentially turning on and scanning the light sources in the row direction as illustrated in FIG. 30(b). In addition, the final full image of the fingerprint pattern may be obtained by combining a full image combined in the column direction and a full image combined in the row direction.

FIG. 31 is a conceptual diagram illustrating still another method in which a display apparatus according to an embodiment of the present invention scans a subj ect.

In FIGS. 31(a) and 31(b), first light sources are arranged at colored coordinates and second light sources are arranged at colorless coordinates, according to an embodiment of the present invention. The first light sources have coordinates of a different wavelength band from the second light sources.

As illustrated in FIG. 31(a), when the first light sources spaced apart by a predetermined distance to minimize the influence of scattered light are turned on, optical sensors in the optical sensor array receive reflected light of a first wavelength band and sense a first image.

Next, as illustrated in FIG. 31(b), when the second light sources spaced apart by a predetermined distance to minimize the influence of scattered light are turned on, the optical sensors in the optical sensor array receive reflected light of a second wavelength band and sense a second image.

Likewise, when the first light sources and the second light sources spaced apart by the predetermined distance are alternately and sequentially turned on, the optical sensor array may respectively obtain the first image and the second image sensed at one frame. Since the influence of reflected light/scattered light differs according to the wavelength band of light as well as the refractive index of an intermediate medium layer disposed between the optical sensors and a subject, a fingerprint image having a better resolution may be finally obtained by combining the first image and the second image.

Although two light sources are used for convenience, embodiments of the present invention may not be limited thereto. In yet another example, after three light sources R, and B are radiated according to the embodiment of the present invention, a fingerprint image may be finally obtained by combining all of an image R, an image and an image B.

In FIGS. 31(a) and 31(b) according to an embodiment of the present invention, light sources having the same wavelength band are used without using light sources having different wavelength bands, and optical sensors deposited to receive reflected light having different wavelength bands may be arranged. That is, although all of the optical sensors disposed in the optical sensor array are the same, a material filtering light of a specific wavelength band is deposited on the optical sensors disposed at the colored coordinates and is not deposited on the optical sensors disposed at the colorless coordinates. As a result, the first image sensed in the colored coordinates and the second image sensed in the colorless coordinates, are obtained in the optical sensor array at one frame. Since the influence of the received reflective light/scattered light is different according to a wavelength band of the light as well as a refractive index of the intermediate medium layer disposed between the optical sensor and the subject, a fingerprint image having higher resolution may be finally obtained by combining the first image and the second image.

As a modified embodiment of FIG. 31, let's assume that the fingerprint of the same user is scanned in a next fingerprint recognition process by using different light sources having different wavelength bands. In this case, the fingerprint is compared to previously registered fingerprint information, and a light source of a wavelength band outputting a fingerprint image having a high degree of similarity than others and a scanning arrangement mechanism of the light source are stored in relation to the user's fingerprint information. Thereby, the mechanism may be used in a next fingerprint recognition process.

In yet another embodiment of the present invention, a first fingerprint image is scanned using a total reflection through a light guide plate, caused by a first light source disposed in a side portion of a display apparatus. Next, a second fingerprint image is scanned using light reflected by a second light source disposed in a lower portion of the display apparatus. The display apparatus generates a final full fingerprint image by combining the first fingerprint image and the second fingerprint image. In this case, the quality of the final full fingerprint image may be improved by using different light irradiation methods.

Hereinafter, a sensor driving circuit configured in the form of a matrix so as to drive a plurality of optical sensors included in an optical sensor array and read out a signal sensed by the plurality of optical sensors will be described according to various embodiments of the present invention.

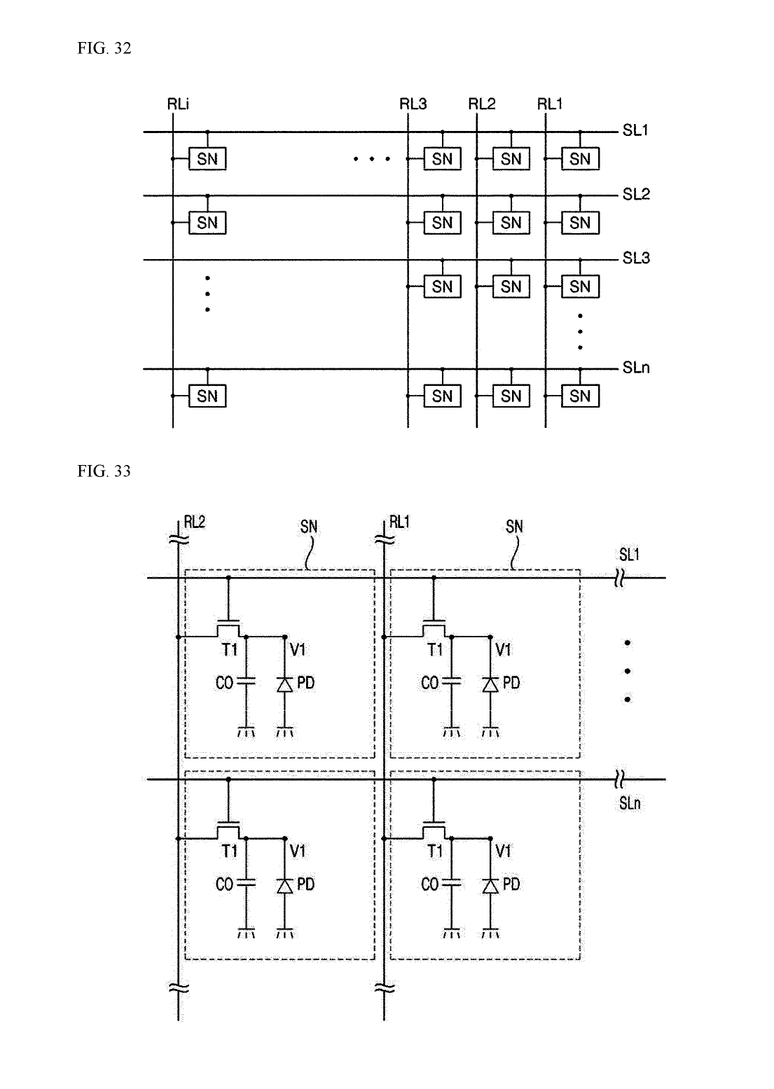

FIG. 32 shows a configuration of an optical sensor array configured to implement a fingerprint sensing function or an image scanning function according to an embodiment of the present invention.

The optical sensor array includes a plurality of scan lines SL1, SL2, . . . , and SLn, and a plurality of read-out lines RL1, RL2, . . . , and RL1. A scan signal may be sequentially supplied to the plurality of scan lines SL1, SL2, . . . , and SLn, and the plurality of read-out lines RL1, RL2, . . . , and RL1 may receive signals output from optical sensors SN and transfer the signals to a circuit (not shown) processing the signals.

The scan lines SL1, SL2, . . . , and SLn and the read-out lines RL1, RL2, . . . , and RL1 are arranged to intersect each other. In addition, at least one optical sensor SN may be formed at each intersection.

FIG. 33 is a circuit diagram illustrating an implementation example of an optical sensor SN illustrated in FIG. 32. Referring to FIG. 33, the optical sensor SN includes a photodiode PD, a transistor T1, and a sensing capacitor C0.

The photodiode PD is a device by which light energy is converted to electric energy, and generates current when light reaches the photodiode PD. A cathode of the photodiode PD is connected to a source of a switch transistor T1, and an anode of the photodiode PD is connected to a ground potential. The photodiode PD may be implemented as an OLED, quantum dots (QD), a transistor, or the like.

An end of the sensing capacitor C0 is connected to the source of the switch transistor T1, and the other end of the sensing capacitor C0 is connected to the ground potential. A response with respect to a potential variation of the end of the sensing capacitor C0 is transferred to a read-out line RL1 or RL2, and a signal transferred to the read-out line RL1 or RL2 is transferred to a predetermined IC chip. A gate electrode of the switch transistor T1 is connected to a scan line SL1, . . . , or SLn, a drain electrode of the switch transistor T1 is connected to the read-out line RL1 or RL2, and a source electrode of the switch transistor T1 is connected to the cathode of the photodiode PD.

The switch transistor T1 may be implemented as a transistor formed of hydrogenated amorphous silicon (a-Si:H), poly silicon (poly-Si), an oxide, or the like, but is not limited thereto. The switch transistor T1 may be implemented as an organic TFT or the like.

A method in which the optical sensors SN senses externally incident light, that is, light reflected by a contact means and incident to the optical sensors SN, and transfers a signal corresponding to the amount of the sensed light, will be described as follows.

A predetermined voltage is applied to the read-out line RL1 or RL2. Here, an additional circuit (not shown) for applying the voltage may be further included. When a select signal to turn on the switch transistor T1 is applied to the scan line SL1, . . . , or SLn, one end potential V1 of the sensing capacitor C0 is set at the voltage applied to the read-out line RL1 or RL2. That is, by turning on the switch transistor T1, the sensing capacitor C0 is set at the voltage applied to the read-out line RL1 or RL2.

When the light reflected by an external object is not incident, there is no current flowing through the photodiode PD. Accordingly, the potential V1 of the end of the sensing capacitor C0 is maintained at the set voltage.

The read-out line R11 or RL2 is reset in a predetermined period. When the read-out line R11 or RL2 is reset to a potential of 0 V, for example, and the next select signal is input to the scan line SL1, . . . , or SLn to turn on the switch transistor T1, charges stored in the sensing capacitor C0 may be shared with a parasitic capacitance (not shown) of the read-out line RL1 or RL2.

When Vdc represents the voltage applied to the read-out line R11 or RL2, Cp1 represents the parasitic capacitance of the read-out line R11 or RL2, and V1 represents the one end potential V1 of the sensing capacitor C0, the following equation is established.

$$V 1 ( CO + Cpl ) = Vdc \times CO \\ V 1 = \frac{Vdc \times CO}{CO + Cpl} \qquad [ Equation 1 ]$$

However, when the light reflected from the external object is incident, the photodiode PD generates current. Accordingly, a total amount of charge shared by the sensing capacitor C0 and the parasitic capacitance of the read-out line R11 or RL2 may change, and thus the one end potential V1 of the sensing capacitor C0 may change according to Equation 1.

As the intensity of the incident light increases, the amount of currents flowing in the photodiode PD increases. Accordingly, variation in the one end potential V1 of the sensing capacitor C0 may also increase, and the total amount of charges shared by the sensing capacitor C0 and the parasitic capacitance of the read-out line R11 or RL2 may also increase. As a result, output signals having different levels depending on the intensity of the light incident to the photodiode PD may be obtained from the read-out line R11 or RL2.

The above-described method is a method using a phenomenon of charge sharing between the sensing capacitor C0 and the parasitic capacitance of the read-out line R11 or RL2. Accordingly, a level difference in output signals actually obtained from the read-out line R11 or RL2 is a difference resulting from sharing charges with the sensing capacitor C0, and thus the level difference in the output signals according to the size and condition of the signal may not be sufficient. Accordingly, an additional circuit for amplifying the output signal of the read-out line R11 or RL2 may be required.

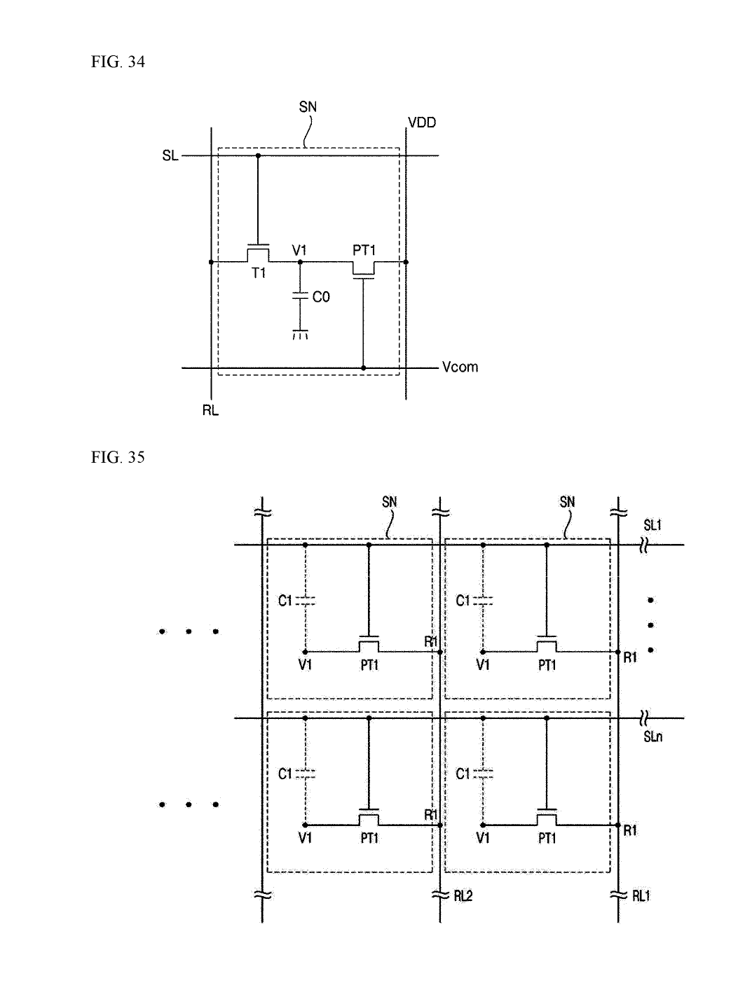

FIG. 34 is a circuit diagram illustrating another implementation of a charge sharing scheme of an optical sensor SN illustrated in FIG. 32.

Referring to FIG. 34, the optical sensor SN may include a switching transistor T1, a sensing transistor PT1, and a sensing capacitor C0.

A gate electrode of the switching transistor T1 is connected to a scan line SL, a drain electrode of the switching transistor T1 is connected to a read-out line RL, and a source electrode of the switching transistor T1 is connected to a first electrode of two electrodes of the sensing capacitor C0. A drain electrode of the sensing transistor PT1 is connected to an input voltage line VDD, a source electrode of the sensing transistor PT1 is connected to the first electrode of the sensing capacitor C0, and a gate electrode of the sensing transistor PT1 is connected to a common voltage line Vcom.

When light reflected from an external object is incident to the sensing transistor PT1, a semiconductor channel formed of amorphous silicon or polysilicon generates current, and the current flow in the direction of the sensing capacitor C0 and the switching transistor T1 due to an input voltage input to the input voltage line VDD.

When a select signal is input to the scan line SL, the current flows through the read-out line RL. At this time, the amount of current actually flowing through the read-out line RL may be decreased due to parasitic capacitance formed around the read-out line RL.

FIG. 35 is a circuit diagram illustrating a configuration of a charge-sharing optical sensor applicable to a display device according to an embodiment of the present invention.

The optical sensor SN according to an embodiment of the present invention may be included in the above-described optical sensor array.

Each optical sensor SN includes only one sensing transistor PT1. The amount of charge generated by the sensing transistor PT1 corresponds to the intensity of light reflected from an external object. In other words, the sensing transistor PT1 receives the light reflected from the external object and generates leakage current corresponding to the intensity of the received light.

A capacitance C1 illustrated in FIG. 35 is not actually provided, but is a parasitic capacitance generated by intersection of a read-out line and a scan line, that is, a gate-source overlap capacitance (Cgso) of a TFT.

A first electrode of the sensing transistor PT1 is connected to one of the scan lines SL1 to SLn, and a second electrode of the sensing transistor PT1 is connected to one of the read-out lines R11 and RL2. A third electrode of the sensing transistor PT1 may be arranged in a floating state without being electrically connected to any component of the circuit. The first electrode, the second electrode, and the third electrode may be a gate electrode, a drain electrode, and a source electrode, respectively. The sensing transistor PT1 may be implemented as a transistor formed of a-Si:H, poly-Si, an oxide, or the like, but is not limited thereto. The sensing transistor PT1 may be implemented as an organic TFT or the like.

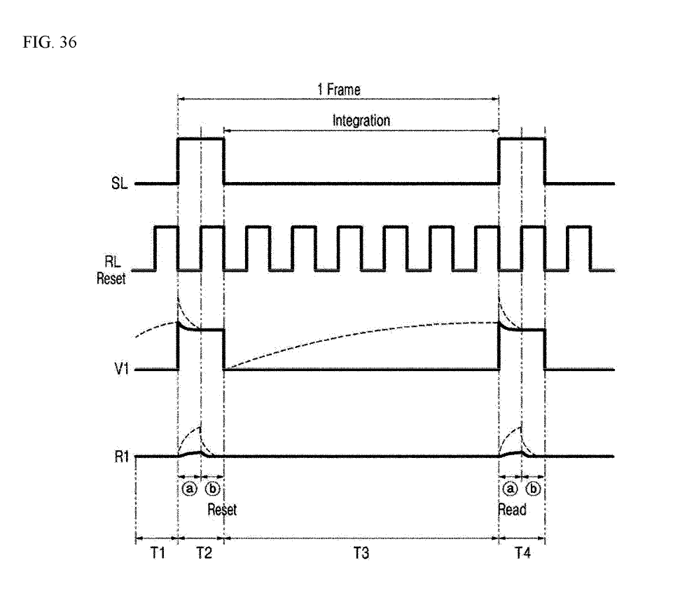

FIG. 36 is a timing diagram for describing an operation of a charge-sharing optical sensor according to an embodiment of the present invention. The operation of the charge-sharing optical sensor according to an embodiment of the present invention will be described with reference to FIGS. 35 and 36.

In FIG. 36, SL represents a signal supplied to the scan lines SL1 to SLn, and it is understood that a select signal is applied to the scan lines SL1 to SLn during a high state period. A specific optical sensor SN is selected by the application of the select signal, and a signal is output from the optical sensor SN. Hereinafter, ‘SL’ represents a scan line signal. In addition, RL Reset represents a signal resetting the read-out lines R11 and RL2. The RL Reset is applied during a high state period to reset the read-out lines R11 and RL2.

V1 represents a potential of the source electrode of the sensing transistor PT1, and R1 represents a potential of a point at which the drain electrode of the sensing transistor PT1 and the read-out lines R11 and RL2 are connected. In the timing diagrams of V1 and R1, a solid line (dark) indicates when the light reflected from the external object is not supplied to the sensing transistor PT1, and a broken line (light) indicates when the light reflected from the external object is supplied to the sensing transistor PT1. The external object may be a touch-generating means or a human fingerprint. A human finger includes ridges and valleys, and a different amount of light is reflected depending on which of the ridges or valleys is in contact with the sensing transistor PT1.

The time taken for the scan line signal SL to be transitioned to a high level and transitioned again to the next high level may be defined as one frame. During a period T2 in which a high level signal is applied to the scan lines SL1 to SLn, coupling may be generated by the parasitic capacitance C1, and the source electrode potential V1 of the sensing transistor PT1 may also increase. More specifically, when a potential of the scan lines SL1 to SLn increases due to appliance of the high level signal, the source electrode potential V1 of the sensing transistor PT1 may also increase due to the coupling phenomenon of the parasitic capacitance C1. Next, when the scan line signal SL falls to a low level, the source electrode potential V1 of the sensing transistor PT1 may also be lowered due to the coupling phenomenon of the parasitic capacitance C1 and reset to an initial value.

First, a case in which the light reflected from an external object is not supplied to the sensing transistor PT1 is described as follows. Since the light is not supplied to the sensing transistor PT1, leakage current may not be generated in the sensing transistor PT1 and accordingly the parasitic capacitance C1 may not be charged during a period T1 in which the scan line signal SL is maintained at a low level.

Referring to the V1 timing diagram illustrated as a solid line in FIG. 36, when the scan line signal SL is transitioned to a high level (the period T2), the source electrode potential V1 of the sensing transistor PT1 may also transition to the same level as the potential of the scan line signal SL due to the coupling phenomenon.

Next, when the RL Reset is transitioned to a high level during a period T3 in which the scan line signal SL is lowered again to the low level, the read-out lines R11 and RL2 are reset to a reset voltage as shown in the R1 timing diagram illustrated as a solid line in FIG. 36. Accordingly, the source electrode potential V1 of the sensing transistor PT1 is lowered and reset to a low level as shown in the V1 timing diagram illustrated as a solid line in FIG. 36. Here, due to the coupling phenomenon occurring between the scan line signal SL and the source electrode of the sensing transistor PT1, the source electrode potential V1 of the sensing transistor PT1 may be lowered more than the low level.

In this manner, since the potential of the scan line signal SL and the source electrode potential V1 of the sensing transistor PT1 are always maintained at the same level, the parasitic capacitance C1 is not charged. In addition, even when the scan line signal SL is at the high level, there is no current flowing into the read-out lines R11 and RL2. Accordingly, a potential R1 of the point at which the sensing transistor PT1 and the read-out lines R11 and RL2 are connected is maintained at the same level in both of the cases in which the scan line signal SL belongs to a high level and a low level.

Next, a case in which the light reflected from the external object is supplied to the sensing transistor PT1 will be described. Even in the period T1 in which the scan line signal SL is maintained at the low level, the parasitic capacitance C1 is charged by the light-induced leakage current of the sensing transistor PT1. Accordingly, the source electrode potential V1 of the sensing transistor PT1 may be gradually raised as shown in the V1 timing diagram illustrated as a broken line in FIG. 36.

When the scan line signal SL transitions to a high level (the period T2), the source electrode potential V1 of the sensing transistor PT1 rises due to the coupling phenomenon of the parasitic capacitance C1. Since the parasitic capacitance C1 is already charged in the period T1, the potential V1 of the parasitic capacitance C1 at a starting point of the period T2 is relatively high compared to when the light is not supplied. That is, since the parasitic capacitance C1 is charged during the period T1, the potential raised due to the coupling phenomenon may be different from that in the case in which the reflected light is not supplied, depending on the amount of charges stored in the parasitic capacitance C1.

During the period T2, when the scan line signal SL transitions to a high level, the charges stored in the parasitic capacitance C1 are transferred to the read-out lines R11 and RL2 through the sensing transistor PT1. Thus, the potential R1 of the point at which the sensing transistor PT1 and the read-out lines R11 and RL2 are connected, that is, a drain electrode potential of the sensing transistor PT1 may gradually increase (the period \textcircled{a}) and the amount of charges stored in the parasitic capacitance C1 may reduce. Accordingly, the source electrode potential V1 of the sensing transistor PT1 may gradually lower (the period \textcircled{b}), which proceeds until the source electrode potential V1 of the sensing transistor PT1 is equal to the potential R1 of the drain electrode of the sensing transistor PT1.

When the reset signal RL Reset is input to the read-out lines R11 and RL2, the potential R1 of the read-out lines R11 and RL2 is gradually lowered to the same level as the period in which the scan line signal SL is maintained at the low level (the period \textcircled{b}). The reset signal RL Reset of the read-out lines R11 and RL2 is periodically supplied, and thus the potential R1 of the read-out lines R11 and RL2 may be periodically reset. The reset period of the potential R1 of the read-out lines R11 and RL2 may be shorter than the time for supplying a high level signal, that is, the select signal, to the scan line signal SL.

When the scan line signal SL transitions to the low level (the period T3), the parasitic capacitance C1 is charged by the leakage current generated by the sensing transistor PT1.

When the light reflected from the external object is supplied to the sensing transistor PT1, the parasitic capacitance C1 is charged by the leakage current. While the scan line signal SL is at the high level, the increment of the source electrode potential V1 of the sensing transistor PT1 may be greater than normal (when the light is not supplied). Accordingly, during the period (the period \textcircled{a}) before the read-out lines R11 and RL2 are reset, a pattern of the potential R1 of the point at which the drain electrode of the sensing transistor PT1 and the read-out lines R11 and RL2 are connected may also be different from normal.

Accordingly, during the period in which the scan line signal SL is maintained at a high level and before the read-out lines R11 and RL2 are reset (the period \textcircled{a}), whether the light reflected from the external object is supplied or not may be determined by observing the change in the drain electrode potential R1 of the sensing transistor PT1, the potential R1 of the point at which the sensing transistor PT1 and the read-out lines R11 and RL2 are connected, or more comprehensively, the potential R1 of the read-out lines R11 and RL2.

In addition, since the amount of leakage current generated by the sensing transistor PT1 and stored in the parasitic capacitance C1 may also change depending on the amount of supplied light, the status of contact (a contact strength, a contact area, or the like) may be recognized by detecting the variation in the potential R1 of the read-out lines R11 and RL2 during the period ®. In other words, since the amount of charge stored in the parasitic capacitance C 1 changes depending on the leakage current generated by the sensing transistor PT1 and the stored charge gradually flows into the read-out lines R11 and RL2 when the select signal is applied, a corresponding output signal may be output from the sensing transistor PT1. By detecting the output signal through the read-out lines R11 and RL2, the contact status above each of the optical sensors SN may be recognized.

When a pattern of variation of the potential R1 detected by the read-out lines R11 and RL2 is transferred to a separate IC chip, whether a display surface corresponding to each pixel is contacted or not and what size the contact area is may be determined through the pattern. In other words, the read-out lines R11 and RL2 may receive a signal corresponding to the amount of charges stored in the parasitic capacitance C1 due to the leakage current of the sensing transistor PT1 of the optical sensor SN in the form of a potential, and whether a display surface is contacted or not and a contact status may be determined through the received potential.

According to an embodiment of the present invention, a charge-sharing optical sensor SN includes only one sensing transistor PT1. That is, it includes one less transistor and one less capacitor than the optical sensor described above with reference to FIG. 33. The optical sensor SN is formed on a substrate including a display area as described above. Since components configuring the optical sensor SN are reduced as described above, an opening ratio with respect to the entire display panel may be significantly improved.

In addition, in the optical sensor in FIG. 33, the source electrode potential V1 of the sensing transistor PT1 needs to be periodically reset. However, the source electrode potential V1 of the sensing transistor PT1 according to an embodiment of the present invention may not require an additional reset signal since it is reset by the read-out line reset signal RL applied to the read-out lines R11 and RL2 during the period in which the select signal applied to the scan lines SL1 to SLn is at the low level. Accordingly, the area of the integrated circuit may be reduced. In the optical sensor-integrated display apparatus, since each pixel of the display apparatus includes the optical sensor, whether each pixel is contacted or not and what size the contact area is may be recognized. In this regard, the display apparatus may not only recognize whether a touch by a touching means occurs or not and where a touch point is, but also have a function of fingerprint recognition since every pixel determines whether ridges or valleys of a fingerprint are contacted when a finger of a user is in contact with the display apparatus. That is, by forming the optical sensors integrated with the display apparatus to have small sizes and small intervals sufficient to distinguish ridges and valleys of a fingerprint, the display apparatus may detect whether a touch occurs or not and recognize a fingerprint. In addition, in detecting whether a touch occurs, resolution may be naturally improved.

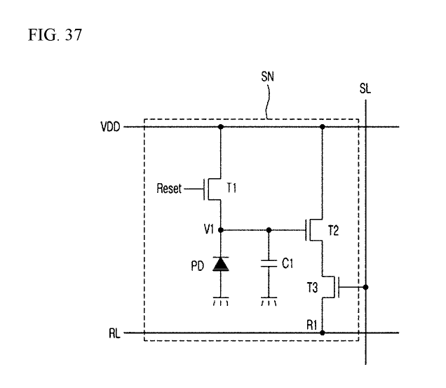

FIG. 37 is a circuit diagram illustrating an implementation of a source follower scheme of the optical sensor SN illustrated in FIG. 32.

Referring to FIG. 37, the source-follower optical sensor SN includes one photodiode PD, three transistors T1, T2, and T3, and one sensing capacitor C1.

The first transistor T1 resets a first electrode potential V1 of the sensing capacitor C1 according to a reset control signal Reset, and is referred to as a reset transistor T1 hereinafter. A source electrode of the reset transistor T1 is connected to a cathode of the photodiode PD, and a drain electrode of the reset transistor T1 is connected to an input voltage line VDD.

A gate electrode of the second transistor T2 is connected to the cathode of the photodiode PD and a first electrode of two electrodes of the sensing capacitor C1. In addition, a drain electrode of the second transistor T2 may be connected to the input voltage line VDD. The second transistor T2 converts the first electrode potential V1 of the sensing capacitor C1 to a current signal and serves to amplify the current signal. Accordingly, the second transistor T2 may be referred to as an amplifying transistor T2.

A gate electrode of the third transistor T3 is connected to a scan line SL, a drain electrode of the third transistor T3 is connected to a source electrode of the amplifying transistor T2, and a source electrode of the third transistor T3 is connected to a read-out line RL. When a select signal is applied to the scan line SL, the third transistor T3 is turned on, and the first electrode potential V1 of the sensing capacitor C1, which is amplified by the amplifying transistor T2, is transferred to the read-out line RL in the form of the current signal. The third transistor T3 may be referred to as a select transistor T3.

The cathode and an anode of the photodiode PD are respectively connected to the first electrode of the sensing capacitor C1 and the ground potential, and the first electrode and the second electrode of the sensing capacitor C1 are respectively connected to the gate electrode of the amplifying transistor T2 and the ground potential.

An operation of the source-follower optical sensor will be described hereinafter.

First, when the reset transistor T1 is turned on by the reset control signal Reset, the first electrode potential V1 of the sensing capacitor C1 is reset to a potential of the input voltage line VDD.

When light reflected by an external object (e.g. a human fingerprint) is supplied to the photodiode PD, leakage current may be generated and the sensing capacitor C1 is charged by the leakage current.

Since the sensing capacitor C1 is charged, a gate electrode potential of the amplifying transistor T2 connected to the first electrode of the sensing capacitor C1 may increase. When the potential exceeds a threshold voltage, the amplifying transistor T2 is turned on so that current flows in the amplifying transistor T2.

When the select signal is applied to the scan line SL and thus the select transistor T3 is turned on, the first electrode potential V1 of the sensing capacitor C1 is amplified by the amplifying transistor T2 and the select transistor T3 and transferred to the read-out line RL in the form of a current signal. Since the current is transferred to the read-out line RL, the potential R1 of the read-out line RL increases. The change in the potential R1 of the read-out line RL occurring while the select signal is applied to the scan line SL is transferred to a separate IC chip and converted to a digital signal through an analog-to-digital converter (ADC).

The potential R1 of the read-out line RL is proportional to the first electrode potential V1 of the sensing capacitor C1, that is, an amount of charge stored in the sensing capacitor C1. Since the amount of charge stored in the sensing capacitor C1 is proportional to the amount of light supplied to the photodiode PD, how much light is supplied to the optical sensor SN may be figured out through the potential R1 of the read-out line RL. In this manner, whether the object is in contact or not and contact conditions (a contact distance, a contact area, and the like) thereof may be recognized for each optical sensor SN.

In the source-follower optical sensor described with reference to FIG. 37, an additional amplifier may be unnecessary since the signal amplified by the amplifying transistor T2 is output, and the signal may be rapidly processed since the signal is detected by directly converting an analog signal into a digital signal. However, due to a large number of transistors, there is a limitation in the amount of space to integrate the transistors in a pixel of the display apparatus, and an opening ratio is small.

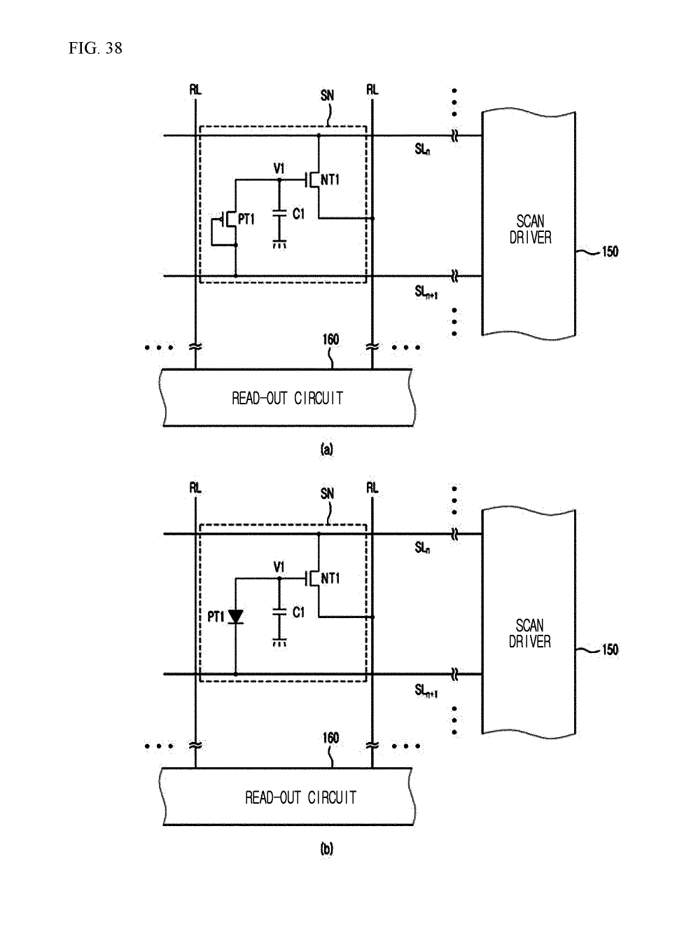

FIG. 38 is a circuit diagram illustrating a configuration of a source-follower optical sensor applicable to a display apparatus according to an embodiment of the present invention. FIG. 38(a) and FIG. 38(b) are equalized circuit diagrams. The optical sensor according to an embodiment of the present invention is basically a source-follower optical sensor.

Referring to FIG. 38, the optical sensor SN according to an embodiment of the present invention may be disposed in the same position as the optical sensor SN described with reference to FIGS. 32 and 33. The optical sensor SN according to an embodiment of the present invention may be disposed in an area that does not overlap a light-transmitting portion of a color filter layer, in a top view.

However, when a transparent electrode material is used in the optical sensor SN, the optical sensor SN may overlap the light-transmitting portion of the color filter layer in the optical sensor array. In this case, since the optical sensor SN may be formed to overlap a unit pixel, the size of each optical sensor SN may be enlarged and thus sensitivity of image scanning may be improved.

Referring to FIG. 38(a), each optical sensor SN includes one p-type transistor PT1, one n-type transistor NT1, and a sensing capacitor C1.

Each of the p-type transistor PT1 and the n-type transistor NT1 may be formed as a silicon-based transistor, such as an a-Si:H transistor, a poly-Si transistor, or an oxide transistor, but is not limited thereto. Each of the p-type transistor PT1 and the n-type transistor NT1 may be implemented as an organic TFT or the like.

The gate electrode and the source electrode of the p-type transistor PT1 are connected to each other and equalized to the photodiode PT1 as shown in FIG. 38(b). The gate electrode and the source electrode of the p-type transistor PT1 are connected to function as a cathode of the photodiode PT1, and a drain electrode of the p-type transistor PT1 may function as an anode. The source electrode of the p-type transistor PT1 is connected to a scan line SLn+1, and the drain electrode of the p-type transistor PT1 is connected to a first electrode of both electrodes of the sensing capacitor C1 and a gate electrode of the n-type transistor NT1.

The gate electrode of the n-type transistor NT1 is connected to the first electrode of the sensing capacitor C1 and the drain electrode of the p-type transistor PT1, and a drain electrode of the n-type transistor NT1 is connected to a read-out line RL. A source electrode of the n-type transistor NT1 is connected to a scan line SLn.

The scan line SLn connected to the source electrode of the n-type transistor NT1 and the scan line SLn+1 connected to the source electrode of the p-type transistor PT1 are different scan lines adjacent to each other. A select signal is applied to a specific optical sensor SN among the plurality of optical sensors SN through the scan line. The select signal may be sequentially applied to the first scan line SLn connected to the source electrode of the n-type transistor, and the second scan line SLn+1 connected to the source electrode of the p-type transistor PT1.

Meanwhile, the sensing capacitor C1 may store charges due to the leakage current generated by the p-type transistor PT 1. The first electrode of the sensing capacitor C1 is connected to the gate electrode of the n-type transistor NT1 and the drain electrode of the p-type transistor PT1, and the second electrode of the sensing capacitor C1 is connected to a ground potential.

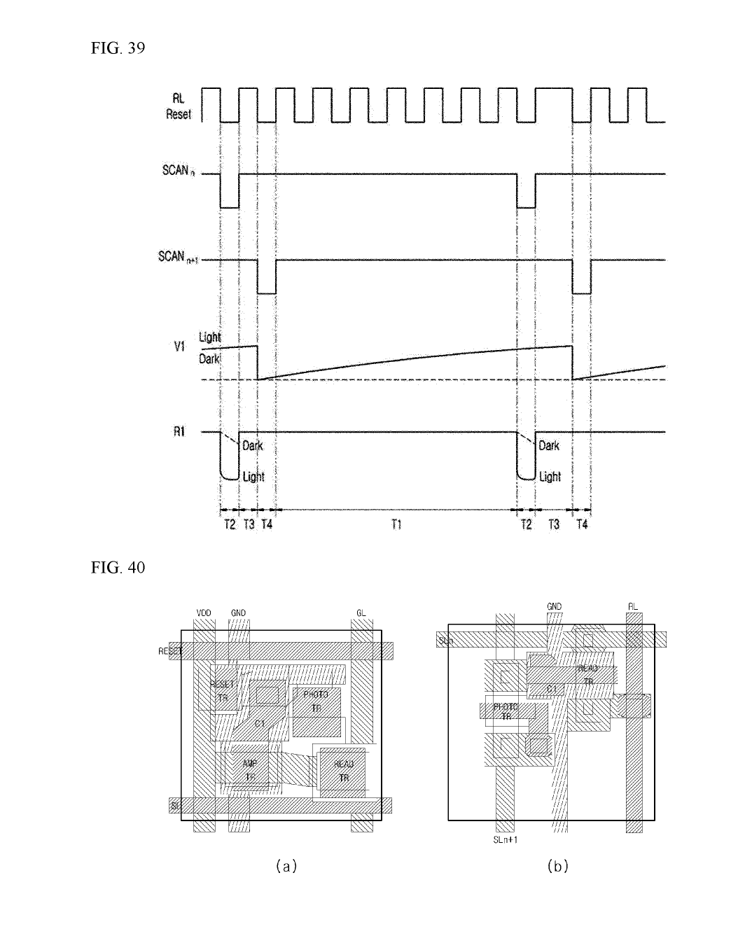

FIG. 39 is a timing diagram for describing an operation of a source-follower optical sensor according to an embodiment of the present invention.

In FIG. 39, RL Reset represents a signal for periodically resetting a potential of the read-out line RL. When RL Reset is at a high level, the potential of the read-out line RL may be reset.

SCANn represents a signal applied to the first scan line SLn, and SCANn+1 represents a signal applied to the second scan line SLn. When the signals SCANn and SCANn+1 supplied to the scan lines SLn and SLn+1 are at a low level, optical sensors SN corresponding thereto are selected. For example, when the signal applied to the first scan line SLn is transitioned to the low level (when a select signal is applied), the optical sensor SN including the n-type transistor NT1 whose drain electrode and source electrode are respectively connected to the read-out line RL and first scan line SLn is selected, and a sensing value sensed by the optical sensor SN is output to the read-out line RL. The interval from when the signals SCANn and SCANn+1 supplied to the scan lines SLn and SLn+1 are transitioned from the high level to the low level, to time when the signals SCANn and SCANn+1 are transitioned again to the low level may be defined as one frame.

V1 represents the first electrode potential V1 of the sensing capacitor C 1, and R1 represents the potential R1 of the read-out line RL. In timing diagrams of V1 and R1, solid lines indicate when light reflected from an external object is supplied to the optical sensors SN (Light), and broken lines indicate when the light is not supplied (Dark).

Hereinafter, an operation of the optical sensor SN will be described with reference to FIGS. 38 and 39.

Since the select signal is not applied to the first scan line SLn and the second scan line SLn+1 during the period T1, there's no current flowing through the n-type transistor NT1 and current flowing from the p-type transistor PT1 to the second scan line SLn+1.

The period T1 is an interval from when a low level signal is applied to the second scan line SLn+1 to when the low level signal is applied to the first scan line SLn. That is, the period T1 comes after the period T4 in which the low level signal is applied to the second scan line SLn+1. When the low level signal is applied to the second scan line SLn+1 during the period T4, the sensing capacitor C1 is reset since the charge stored in the sensing capacitor C1 flows out through the p-type transistor PT1 which serves as a photodiode. Accordingly, the first electrode potential V1 of the sensing capacitor C1 is 0 V during the period T4.

The select signal is not applied to the first scan line SLn and the second scan line SLn+1 during the period T1. Accordingly, when leakage current is generated in the p-type transistor PT1 serving as a photodiode, charge due to the leakage current is stored in the sensing capacitor C1.

When the light reflected from the external object is not supplied, the leakage current is not generated in the p-type transistor PT1. Accordingly, the sensing capacitor C1 connected to the drain electrode of the p-type transistor PT1 is not charged, and the first electrode potential V1 of the sensing capacitor C1 is maintained at a low level (Dark).

Conversely, when the light reflected from the external object is supplied during the period T1, a leakage current is generated in the p-type transistor PT1 as described above. The sensing capacitor C1 is charged by the leakage current, and the charging continues until the low level signal is applied to the second scan line SLn+1, that is, for one frame. Accordingly, the first electrode potential V1 of the sensing capacitor C1 is gradually increased (Light).

Here, when the signal SCANn supplied to the first scan line SLn is transitioned from the high level to the low level (the period T2), a source electrode potential of the n-type transistor NT1 becomes lower than a drain electrode potential of the n-type transistor NT1.

When the light reflected from the external object is not supplied, a gate electrode potential of the n-type transistor NT1 may be lower than a threshold voltage and the n-type transistor NT1 may not be turned on since the sensing capacitor C1 is not charged during the period T1. Accordingly, a small amount of current or no current flows in the n-type transistor NT1, and the potential R1 of the read-out line RL may be maintained at the same level as that in the period T1 or lowered to some extent to flow a small current (Dark).

However, when the light reflected from the external object is supplied, current flows from the drain electrode to the source electrode of the n-type transistor NT1 since the gate electrode potential V1 of the n-type transistor NT1 is higher than the threshold voltage. That is, current flows from the read-out line RL to the first scan line SLn. The amount of the flowing current is proportional to the gate electrode potential of the n-type transistor NT1, that is, the first electrode potential V1 of the sensing capacitor C1. As the intensity of the light reflected from the external object increases, the amount of the leakage current generated in the p-type transistor PT1 increases, and thus the first electrode potential V1 of the sensing capacitor C1 increases. Accordingly, a width of decrease in the potential R1 of the read-out line RL lowering due to the current flowing through n-type transistor NT1 during the period T2 is proportional to the intensity of the supplied light. That is, as the intensity of the light reflected from the external object increases, the potential R1 of the read-out line RL is significantly lowered during the period T2 (Light). During the period T2, that is, while the low level signal is applied to the first scan line SLn, the value of the potential R1 of the read-out line RL is transferred to a separate IC chip. Based on the value, whether a portion above the optical sensor SN in the display apparatus is contacted or not, and the contact conditions thereof may be recognized.

Since each pixel of the display apparatus includes the optical sensor SN, whether each pixel is contacted or not and the contact conditions thereof may be recognized. In addition, the display apparatus may not only recognize whether a touch by a touching means occurs or not and where a touch point is, but also have a fingerprint recognition function since every pixel determines whether ridges or valleys of a fingerprint are contacted when a finger of a user is in contact with the display apparatus.

After the period T2, a reset signal RL Reset is applied to initialize the potential R1 of the read-out line RL, and accordingly the potential R1 of the read-out line RL is initialized to the same level as that before the low level signal is applied to the first scan line SLn.

When the potential R1 of the read-out line RL is reset, and the signal SCANn+1 supplied to the second scan line SLn+1 is transitioned from the high level to the low level (the period T4), all of the charges stored in the sensing capacitor C1 flow out to the second scan line SLn+1 through the p-type transistor PT1. Accordingly, the first electrode potential V1 of the sensing capacitor C1 is initialized. Next, when the period in which the low level signal is applied to the second scan line SLn+1 is finished, the above-described operations of the periods T1, T2, and T3 are repeated again.

When the normal source-follower optical sensor described with reference to FIG. 37 is equalized by replacing the photodiode PD with a transistor and compared with the source-follower optical sensor, described with reference to FIG. 38, according to an embodiment of the present invention, the optical sensor SN according to an embodiment of the present invention includes two less transistors than the normal source-follower optical sensor. In this regard, since the optical sensor SN is formed on a substrate including a display area, and components configuring the optical sensor SN are reduced in the optical sensor SN according to an embodiment of the present invention, an opening ratio with respect to the entire display panel may be improved.

FIG. 40 is a plan view illustrating a layout of a circuit structure of a source-follower optical sensor according to an embodiment of the present invention. FIG. 40(a) shows a structure of a normal optical sensor described with reference to FIG. 37, and FIG. 40(b) shows a structure of the optical sensor, described with reference to FIG. 38, according to an embodiment of the present invention.

Referring to FIG. 40(a), the normal source-follower optical sensor requires four transistors and one capacitor. However, referring to FIG. 40(b), the source-follower optical sensor according to an embodiment of the present invention requires only two transistors and one capacitor.

According to an embodiment of the present invention, a circuit area may be reduced (about 27%) compared to that of the normal source-follower optical sensor. In addition, when the optical sensor is integrated with a display apparatus, an opening ratio thereof may be improved.

In addition, an embodiment of the present invention can still take advantage of the source follower scheme, in which a large detection signal can be obtained with no amplifier.

According to an embodiment of the present invention, a display apparatus includes a cover window providing durability suitable for user environment of a mobile device, and a transparent optical amplification layer compensating degradation in sensitivity of an optical sensor due to the cover window. Therefore, the display apparatus having an image scanning function according to the embodiment of the present invention provides durability in addition to an excellent fingerprint sensing performance.

In addition, according to an embodiment of the present invention, since an optical sensor array for sensing a fingerprint is disposed adjacent to a display surface and overlapped by a shielding pattern such as a black matrix, a display apparatus having an image scanning function can secure a sensitivity sufficient to sense a fingerprint with no degradation in display performance, such as an opening ratio and a resolution.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A display apparatus having an image scanning function, comprising:
an optical amplification cover, one side of which forms a display surface, including a transparent optical amplification layer configured to amplify an optical pattern generated by a fingerprint of a user in contact with the display surface and a cover window for reinforcement;
a thin film transistor (TFT) array configured to drive a plurality of pixels forming an image; and
an optical sensor array disposed between the optical amplification cover and the TFT array and configured to sense the optical pattern amplified by the optical amplification cover.

2. The display apparatus having an image scanning function of claim 1, wherein the transparent optical amplification layer includes a plurality of quantum dots absorbing light of a first wavelength band and emitting light of a second wavelength band different from the first wavelength band.

3. The display apparatus having an image scanning function of claim 2, wherein the first wavelength band belongs to a band of visible light and the second wavelength band belongs to a band of infrared light.

4. The display apparatus having an image scanning function of claim 1, wherein the transparent optical amplification layer includes a polarization-converting layer, and the polarization-converting layer includes a plurality of quantum dots absorbing first polarized light and emitting second polarized light whose polarization axis is substantially perpendicular to that of the first polarized light.

5. The display apparatus having an image scanning function of claim 1, wherein the optical amplification cover comprises:
a cover window, one side of which forms a display surface; and
a transparent optical amplification layer formed on the other side of the display surface of the cover window.

6. The display apparatus having an image scanning function of claim 1, wherein the optical amplification cover comprises:
a cover window;
a transparent optical amplification layer formed on an upper surface of the cover window
a protection layer formed on an upper surface of the transparent optical amplification layer and having a surface forming a display surface, and
the optical sensor array is formed on a lower surface of the cover window.

7. The display apparatus having an image scanning function of claim 1, wherein the TFT array and the optical sensor array two-dimensionally overlap with each other to form a part of a sensor-integrated display panel.

8. The display apparatus having an image scanning function of claim 7, wherein the sensor-integrated display panel is a liquid crystal display (LCD) panel and comprises:
a lower substrate portion including a TFT array configured to drive the plurality of pixels on an inner side of a lower substrate; and
an upper substrate portion including a black matrix formed to correspond to an opaque portion of the TFT array and shielding visible light and an optical sensor array disposed to overlap the black matrix on an inner side of an upper substrate.

9. The display apparatus having an image scanning function of claim 8, wherein the black matrix is formed of an infrared filter resin shielding visible light and transmitting infrared light, and
the optical sensor array includes a plurality of infrared sensors.

10. The display apparatus having an image scanning function of claim 9, wherein the plurality of infrared sensors are respectively arranged to two-dimensionally overlap TFTs configured to drive pixel electrodes in the TFT array.

11. The display apparatus having an image scanning function of claim 8, wherein the optical sensor array includes a metal interconnection and an optical sensor disposed on an inner side of the black matrix.

12. The display apparatus having an image scanning function of claim 11, wherein the upper substrate portion further includes an optical waveguide formed in a portion of the black matrix corresponding to the optical sensor.

13. The display apparatus having an image scanning function of claim 11, wherein the upper substrate portion further includes at least one microlens formed in a portion corresponding to the optical sensor.

14. The display apparatus having an image scanning function of claim 8, wherein the optical sensor array includes an interconnection and an optical sensor disposed between the upper substrate and the black matrix.

15. The display apparatus having an image scanning function of claim 14,
wherein the interconnection is a transparent electrode interconnection, or a metal interconnection including an anti-reflection layer formed on a surface thereof in contact with the upper substrate.

16. The display apparatus having an image scanning function of claim 1, wherein the optical amplification cover is configured in such a manner that infrared light incident on the transparent optical amplification layer that satisfies total internal reflection conditions is scattered by the fingerprint in contact with the display surface and emitted to the optical sensor array.

17. A display apparatus having an image scanning function, comprising:
a lower substrate portion including a thin film transistor (TFT) array configured to drive a plurality of pixels on an inner side of a lower substrate;
an upper substrate portion including a black matrix formed to correspond to an opaque portion of the TFT array and shielding visible light and an optical sensor array disposed to overlap the black matrix, on an inner side of an upper substrate; and
a liquid crystal layer disposed between the lower substrate portion and the upper substrate portion.

18. The display apparatus having an image scanning function of claim 17, wherein the black matrix is formed of an infrared filter resin shielding visible light and transmitting infrared light, and
the optical sensor array includes a plurality of infrared sensors.

19. The display apparatus having an image scanning function of claim 18, wherein the plurality of infrared sensors are respectively arranged to two-dimensionally overlap TFTs configured to drive pixel electrodes in the TFT array.

20. The display apparatus having an image scanning function of claim 17, wherein the optical sensor array includes a metal interconnection and an optical sensor disposed on an inner side of the black matrix.

21. The display apparatus having an image scanning function of claim 20, wherein the upper substrate portion further includes an optical waveguide formed in a portion of the black matrix corresponding to the optical sensor.

22. The display apparatus having an image scanning function of claim 20, wherein the upper substrate portion further includes at least one microlens formed in a portion corresponding to the optical sensor.

23. The display apparatus having an image scanning function of claim 17, wherein the optical sensor array includes an interconnection and an optical sensor disposed between the upper substrate and the black matrix.

24. The display apparatus having an image scanning function of claim 23,
wherein the interconnection is a transparent electrode interconnection, or a metal interconnection including an anti-reflection layer on a surface thereof in contact with the upper substrate.

25. A display apparatus having an image scanning function, comprising:
an optical amplification cover, one side of which forms a display surface, configured to amplify an optical pattern generated by a fingerprint of a user in contact with the display surface;
a display panel including a thin film transistor (TFT) array configured to drive a plurality of pixels forming an image; and
an optical sensor array disposed between the optical amplification cover and the TFT array and configured to sense the optical pattern amplified by the optical amplification cover,
wherein the optical sensor array is integrated with the optical amplification cover and two-dimensionally overlaps a black matrix of the display panel.
